(19) United States
(12) Patent Application Publication
(10) Pub. No.: US 2025/0330642 A1
(43) Pub. Date: Oct. 23, 2025

(54) ENCODING METHOD, DECODING METHOD, BITSTREAM, ENCODER, DECODER, AND STORAGE MEDIUM

(71) Applicant: GUANGDONG OPPO MOBILE TELECOMMUNICATIONS CORP., LTD., Dongguan (CN)

(72) Inventor: ZeXing SUN, Dongguan (CN)

(21) Appl. No.: 19/256,643

(22) Filed: Jul. 1, 2025

Related U.S. Application Data
(63) Continuation of application No. PCT/CN2023/070922, filed on Jan. 6, 2023.

(51) Int. Cl. H04N 19/597; H04N 19/196

(52) U.S. Cl. CPC H04N 19/597; H04N 19/196

(57) ABSTRACT

Embodiments of the present disclosure disclose a decoding method. The method includes: determining planar structure information of neighborhood nodes of a current node; determining context indication information of the current node according to the planar structure information of the neighborhood nodes; determining target context information according to the context indication information; and decoding a bitstream based on the target context information to determine planar position information of the current node.

### CROSS-REFERENCE TO RELATED APPLICATION

This application is a Continuation Application of International Application No. PCT/CN2023/070922 filed on Jan. 6, 2023, which is incorporated herein by reference in its entirety.

### TECHNICAL FIELD

Embodiments of the present disclosure relate to the technical field of point cloud encoding and decoding, and in particular, to an encoding and decoding method, a bitstream, an encoder, a decoder and a storage medium.

### BACKGROUND

In a Geometry-Based Point Cloud Compression (G-PCC) encoding and decoding framework, geometry information of a point cloud and attribute information corresponding to each point are encoded separately. For the geometry information, the encoding and decoding approaches may be divided into octree-based geometric encoding and decoding and predictive tree-based geometric encoding and decoding.

In the related art, when a current node satisfies a condition for planar coding, geometric coding efficiency of the current node is reduced due to incomplete consideration, for example, predictive coding is performed on planar position information of the current node only based on partial prior reference information.

### SUMMARY

The embodiments of the present disclosure provide an encoding and decoding method, a bitstream, an encoder, a decoder and a storage medium.

The technical solutions of the embodiments of the present disclosure may be implemented as follows.

In a first aspect, the embodiments of the present disclosure provide a decoding method. The method is applied to a decoder and includes:
determining planar structure information of neighborhood nodes of a current node;
determining context indication information of the current node according to the planar structure information of the neighborhood nodes;
determining target context information according to the context indication information; and decoding a bitstream based on the target context information to determine planar position information of the current node.
In a second aspect, the embodiments of the present disclosure provide an encoding method. The method is applied to an encoder and includes:
determining planar structure information of neighborhood nodes of a current node;
determining context indication information of the current node according to the planar structure information of the neighborhood nodes;
determining target context information according to the context indication information;
determining planar position information of the current node; and encoding the planar position information of the current node based on the target context information, and signalling obtained encoded bits into a bitstream.

In a third aspect, the embodiments of the present disclosure provide a bitstream. The bitstream is generated by bit encoding according to information to be encoded; and the information to be encoded includes at least: planar position information of a current node.

In a fourth aspect, the embodiments of the present disclosure provide an encoder. The encoder includes a first determining unit and an encoding unit; where
the first determining unit is configured to determine planar structure information of neighborhood nodes of a current node; determine context indication information of the current node according to the planar structure information of the neighborhood nodes; determine target context information according to the context indication information; and determine planar position information of the current node; and
the encoding unit is configured to encode the planar position information of the current node based on the target context information, and signal obtained encoded bits into a bitstream.

In a fifth aspect, the embodiments of the present disclosure provide an encoder. The encoder includes a first memory and a first processor; where
the first memory is configured to store a computer program executable on the first processor; and
the first processor is configured to perform the method described in the second aspect when executing the computer program.

In a sixth aspect, the embodiments of the present disclosure provide a decoder. The decoder includes a second determining unit and a decoding unit; where
the second determining unit is configured to determine planar structure information of neighborhood nodes of a current node; determine context indication information of the current node according to the planar structure information of the neighborhood nodes; and determine target context information according to the context indication information; and
the decoding unit is configured to decode a bitstream based on the target context information to determine planar position information of the current node.

In a seventh aspect, the embodiments of the present disclosure provide a decoder. The decoder includes a second memory and a second processor; where
the second memory is configured to store a computer program executable on the second processor; and
the second processor is configured to perform the method described in the first aspect when executing the computer program.

In an eighth aspect, the embodiments of the present disclosure provide a non-transitory computer-readable storage medium. The non-transitory computer-readable storage medium has a computer program stored thereon, and the computer program, when executed, implements the method described in the first aspect, or the method described in the second aspect.

In a ninth aspect, the embodiments of the present disclosure provide a non-transitory computer-readable storage medium. The non-transitory computer-readable storage medium has a computer program and a bitstream stored thereon, and the computer program, when executed by a processor, enables the processor to perform the method described in the second aspect to generate the bitstream.

### BRIEF DESCRIPTION OF THE DRAWINGS

FIG. 1A is a schematic diagram of a three-dimensional point cloud picture.

FIG. 1B is a partially enlarged schematic diagram of a three-dimensional point cloud picture.

FIG. 2A is a schematic diagram of a point cloud picture at different viewing angles.

FIG. 2B is a schematic diagram of a data storage format corresponding to FIG. 2A.

FIG. 3 is a schematic diagram of a network architecture of point cloud encoding and decoding.

FIG. 4A is a schematic diagram of composition blocks of a G-PCC encoder.

FIG. 4B is a schematic diagram of composition blocks of a G-PCC decoder.

FIG. 5A is a schematic diagram of a low planar position.

FIG. 5B is a schematic diagram of a high planar position.

FIG. 6 is a schematic diagram of a node encoding sequence.

FIG. 7A is a schematic diagram of planar flag information.

FIG. 7B is another schematic diagram of planar flag information.

FIG. 8 is a schematic diagram of infer direct coding model (IDCM) encoding.

FIG. 9A is a schematic diagram of vertexes of a sub-block.

FIG. 9B is a schematic diagram of a triangle patch fitting of a sub-block.

FIG. 9C is a schematic diagram of upsampling of a sub-block.

FIG. 10 is a schematic flowchart of a decoding method provided by the embodiments of the present disclosure.

FIG. 11 is a schematic diagram of position relationship between a current node and neighborhood nodes provided by the embodiments of the present disclosure.

FIG. 12 is a schematic diagram of a neighborhood node at a same partitioning depth and a same coordinate provided by the embodiments of the present disclosure.

FIG. 13 is a schematic flowchart of an encoding method provided by the embodiments of the present disclosure.

FIG. 14 is a schematic diagram of sibling nodes of a current node provided by the embodiments of the present disclosure.

FIG. 15 is an intersection schematic diagram of a laser radar and a node provided by the embodiments of the present disclosure.

FIG. 16A to FIG. 16C are schematic diagrams of a current node located at a low planar position of a parent node provided by the embodiments of the present disclosure.

FIG. 17A to FIG. 17C are schematic diagrams of a current node located at a high planar position of a parent node provided by the embodiments of the present disclosure.

FIG. 18 is a schematic diagram of predictive encoding of planar position information of a laser radar point cloud provided by the embodiments of the present disclosure.

FIG. 19 is a schematic structure diagram of compositions of an encoder provided by the embodiments of the present disclosure.

FIG. 20 is a schematic diagram of a specific hardware structure of an encoder provided by the embodiments of the present disclosure.

FIG. 21 is a schematic structure diagram of compositions of a decoder provided by the embodiments of the present disclosure.

FIG. 22 is a schematic diagram of a specific hardware structure of a decoder provided by the embodiments of the present disclosure.

FIG. 23 is a schematic structure diagram of compositions of an encoding and decoding system provided by the embodiments of the present disclosure.

### DETAILED DESCRIPTION

To provide a more detailed understanding of the features and technical content of the embodiments of the present disclosure, the implementations of the embodiments of the present disclosure will be described in detail below in conjunction with the accompanying drawings. The accompanying drawings are for reference and illustration only and not intended to limit the embodiments of the present disclosure.

Unless defined otherwise, all technical and scientific terms used herein have the same meaning as commonly understood by those skilled in the art belonging to the present disclosure. The terms used herein are for the purpose of describing the embodiments of the present disclosure only and not intended to limit the present disclosure.

In the following description, reference is made to “some embodiments”, which describe a subset of all possible embodiments. However, it is to be understood that “some embodiments” may be the same subset or different subsets of all possible embodiments and be combined with each other without conflict.

It should also be noted that the terms “first\second\third” involved in the embodiments of the present disclosure are merely used to distinguish similar objects and do not represent a specific order for the objects. It is to be understood that “first\second\third” may, where permitted, interchange their specific order or sequence, so that the embodiments of the present disclosure described here can be implemented in an order other than that illustrated or described here.

A point cloud is a three-dimensional representation form of a surface of an object. Point cloud (data) on the surface of the object may be collected through acquisition devices such as a photoelectric radar, a laser radar, a laser scanner or a multi-view camera.

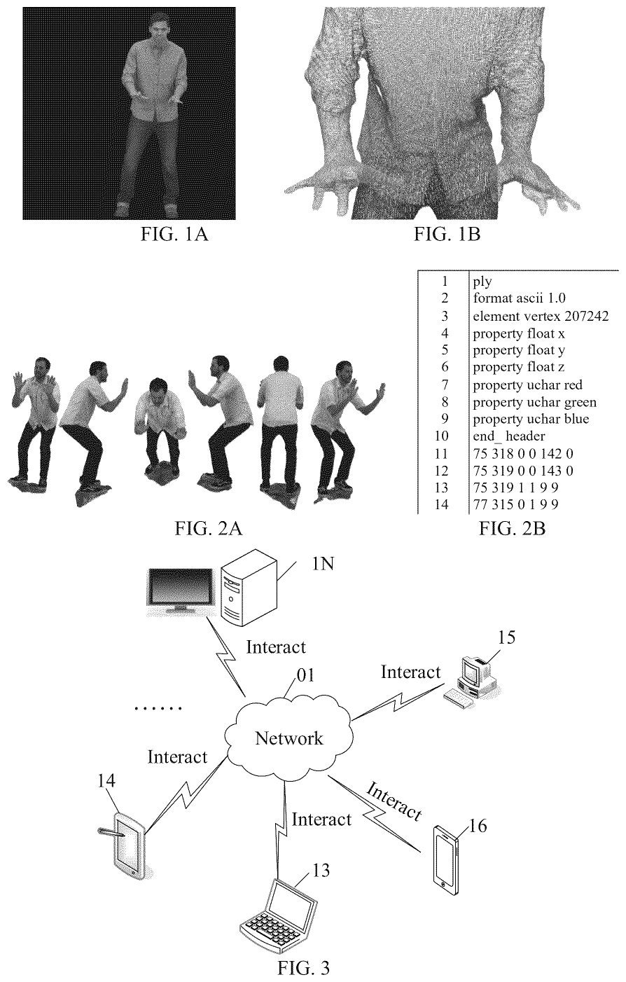

The point cloud is a set of discrete points in space that are irregularly distributed and express the spatial structure and surface attributes of a three-dimensional object or scenario. FIG. 1A illustrates a three-dimensional point cloud picture and FIG. 1B illustrates a partially enlarged view of a three-dimensional point cloud picture. It can be seen that the point cloud surface is composed of densely distributed points.

A two-dimensional picture has information expression at each pixel point and the distribution is regular, so there is no need to record its position information additionally. However, the distribution of points in the point cloud is random and irregular in three-dimensional space, so it is necessary to record the position of each point in space to completely express the entire point cloud. Similar to the two-dimensional picture, during the acquisition process, each position has corresponding attribute information (RGB color values usually), and the color values reflect the color of the object. For the point cloud, in addition to color information, the attribute information corresponding to each point also commonly includes a reflectance value, and the reflectance value reflects the surface material of the object. Therefore, a point in the point cloud may include position information of the point and attribute information of the point. For example, the position information of the point may be three-dimensional coordinate information (x, y, z) of the point. The position information of the point may also be referred to as geometry information of the point. For example, the attribute information of the point may include color information (three-dimensional color information) and/or reflectance (one-dimensional reflectance information r), or the like. For example, the color information may be information in any color space. For example, the color information may be RGB information, where R represents red (R), G represents green (G) and B represents blue (B). For another example, the color information may be luma-chroma (YCbCr, YUV) information, where Y represents luminance (Luma), Cb (U) represents blue chromatic aberration and Cr (V) represents red chromatic aberration.

For a point cloud obtained according to the laser measurement principle, a point in the point cloud may include three-dimensional coordinate information of the point and a reflectance value of the point. For another example, a point cloud obtained according to the photogrammetry principle, a point in the point cloud may include three-dimensional coordinate information of the point and three-dimensional color information of the point. For another example, for a point cloud obtained by combining the laser measurement principle and photogrammetry principle, a point in the point cloud may include three-dimensional coordinate information of the point, a reflectance value of the point and three-dimensional color information of the point.

FIG. 2A and FIG. 2B illustrate a point cloud picture and its corresponding data storage format, respectively. FIG. 2A provides six viewing angles of the point cloud picture, and FIG. 2B consists of a file header information part and a data part. The header information includes a data format, a data representation type, the total number of points in the point cloud and content represented by the point cloud. For example, the point cloud is in “.ply” format, represented by ASCII code, and has a total of 207242 points. Each point has three-dimensional coordinate information (x, y, z) and three-dimensional color information (r, g, b).

Point clouds may be classified into following three types according to the ways of acquisition:
a static point cloud: that is, an object is static, and a device for acquiring the point cloud is also static;
a dynamic point cloud: an object is dynamic, but a device for acquiring the point cloud is static; and
a dynamically acquired point cloud: a device for acquiring the point cloud is dynamic.

For example, point clouds may be classified into two types according to purposes:
type I: a machine perception point cloud, which may be used for scenarios, such as, an autonomous navigation system, a real-time inspection system, a geographic information system, a visual sorting robot, and a disaster relief robot; and
type II: a human eye perception point cloud, which may be used for point cloud application scenarios, such as, digital cultural heritage, free viewpoint broadcasting, 3D immersive communication, and 3D immersive interaction.

The point cloud may express the spatial structures and surface attributes of three-dimensional objects or scenarios flexibly and conveniently; and since the point cloud is acquired by directly sampling real objects, the point cloud provides a strong sense of reality while ensuring accuracy. Therefore, the point cloud is widely applied, and its applied range includes a virtual reality game, a computer-aided design, a geographic information system, an automatic navigation system, digital cultural heritage, free viewpoint broadcasting, three-dimensional immersive remote presentation, and three-dimensional reconstruction of biological tissues and organs or the like.

The collection of the point cloud mainly includes the following ways: computer generation, 3D laser scanning, 3D photogrammetry or the like. The computer may generate point clouds of virtual three-dimensional objects and scenarios; 3D laser scanning may obtain point clouds of static real-world three-dimensional objects or scenarios, and may obtain millions of point clouds per second; and 3D photogrammetry may obtain point clouds of dynamic real-world three-dimensional objects or scenarios, and may obtain tens of millions of point clouds per second. These technologies reduce the cost and time period of point cloud data acquisition and improve the accuracy of data. The change in the way for acquiring point cloud data makes it possible to acquire a large amount of point cloud data. However, with the growth of application demand, the processing of massive 3D point cloud data has encountered the bottleneck in storage space and transmission bandwidth limitation.

For example, taking a point cloud video with a frame rate of 30 frames per second (fps) as an example, the number of points of the point cloud per frame is 700,000, and each point has coordinate information xyz (float) and color information RGB (uchar); and thus, the data volume of a 10 s point cloud video is approximately 0.7 million×(4Byte×3+1Byte×3)×30 fps×10 s=3.15 GB, where 1Byte is 8 bit. For a two-dimensional video with a YUV sampling format of 4:2:0, a resolution of 1280×720 and a frame rate of 24 fps, the data volume of a 10 s video is approximately 1280×720×12 bit×24 fps×10 s≈0.33 GB, and the data volume of a 10 s three-dimensional video with two-viewpoints is approximately 0.33×2=0.66 GB. It can be seen that, for videos with the same length, the data volume of point cloud video is much larger than that of two-dimensional video or that of three-dimensional video. Therefore, in order to better realize data management, save server storage space and reduce the transmission traffic and transmission time between the server and the client, point cloud compression has become a key issue to promote the development of the point cloud industry.

That is, since the point cloud is a collection of massive points, storing the point cloud not only consumes a lot of memory, but also causes inconvenient for transmission; and there is no such large bandwidth to support direct transmission of the point cloud at the network layer without compression. Therefore, the point cloud needs to be compressed.

At present, a point cloud encoding framework that could perform compression on the point cloud may be a G-PCC encoding and decoding framework or a Video-based Point Cloud Compression (V-PCC) encoding and decoding framework provided by the Moving Picture Experts Group (MPEG), or may be an Audio Video Standard-PCC (AVS-PCC) encoding and decoding framework provided by the AVS. The G-PCC encoding and decoding framework may be used to perform compression on a first type of static point cloud and a third type of dynamically acquired point cloud, and the V-PCC encoding and decoding framework may be used to perform compression on a second type of dynamic point cloud. The G-PCC encoding and decoding framework is also referred to as a point cloud codec (encoder/decoder) TMC13, and the V-PCC encoding and decoding framework is also referred to as a point cloud codec TMC2.

The embodiments of the present disclosure provide a network architecture of a point cloud encoding and decoding system including a decoding method and an encoding method. FIG. 3 is a schematic diagram of a network architecture of point cloud encoding and decoding provided in the embodiments of the present disclosure. As illustrated in FIG. 3, the network architecture includes one or more electronic devices 13 to 1N and a communication network 01, where the electronic devices 13 to 1N may perform video interaction through the communication network 01. During the implementation process, the electronic device may be various types of devices with point cloud encoding and decoding functions. For example, the electronic device may include a mobile phone, a tablet computer, a personal computer, a personal digital assistant, a navigator, a digital phone, a video phone, a television, a sensor device, a server, or the like, and the embodiments of the present disclosure are not limited thereto.

The decoder or encoder in the embodiments of the present disclosure may be the above electronic device. That is, the electronic device in the embodiment of the present disclosure has point cloud encoding and decoding functions, and generally, the electronic device includes a point cloud encoder (i.e., encoder) and a point cloud decoder (i.e., decoder).

The point cloud compression technology will be described by taking the G-PCC encoding and decoding framework as an example below.

It is to be understood that in the point cloud G-PCC encoding and decoding framework, for the point cloud data to be encoded, the point cloud data is partitioned into multiple slices through slice partitioning firstly. In each slice, the geometry information of the point cloud and the attribute information corresponding to each point cloud are encoded separately.

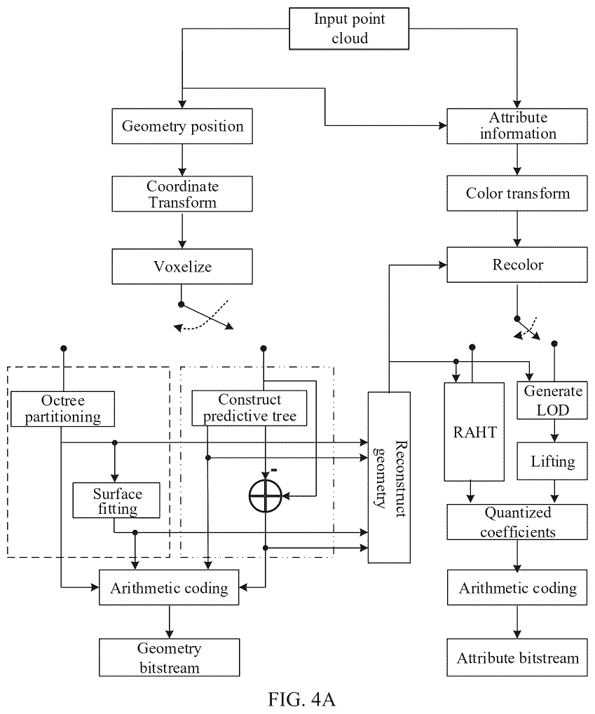

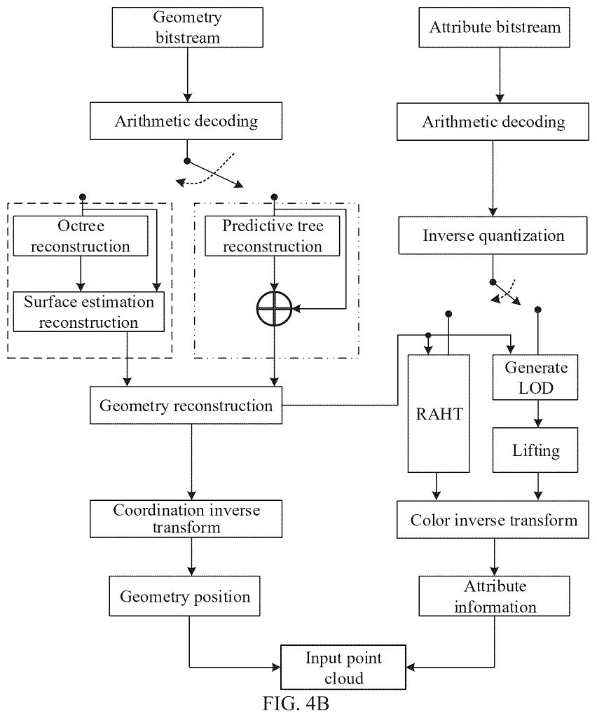

FIG. 4A illustrates a schematic diagram of a composition framework of a G-PCC encoder. As illustrated in FIG. 4A, during the geometry encoding process, coordinate transform is performed on the geometry information, so that all point clouds are included in a Bounding Box, and then, quantization is performed, where the process of quantization mainly plays the role of scaling. Due to quantization and rounding, the geometry information of part of the point cloud is the same, and it is determined whether to remove duplicate points based on parameters. The process of quantization and removal of duplicate points is also referred to as voxelization process. Then, octree partitioning or predictive tree construction is performed on the Bounding Box. During this process, arithmetic encoding is performed on points among the partitioned leaf nodes to generate a binary geometry bitstream; or arithmetic encoding is performed on vertexes generated by partitioning (surface fitting is performed based on the vertexes) to generate a binary geometry bitstream. During the attribute encoding process, after geometry encoding is completed and the geometry information is reconstructed, color transform is required firstly, to transform the color information (i.e., attribute information) from the RGB color space to the YUV color space. Then, recoloring is performed on the point cloud using the reconstructed geometry information, so that the unencoded attribute information is corresponded to the reconstructed geometry information. Attribute encoding is mainly performed for the color information. During the process of color information encoding, there are two main transform methods: one is the distance-based lifting transform that depends on level of detail (LOD) partitioning, and the other is the direct region adaptive hierarchical transform (RAHT). Both methods could transform the color information from the spatial domain to the frequency domain, and obtain high-frequency coefficients and low-frequency coefficients through transform. Finally, quantization is performed on the coefficients, and next, arithmetic encoding is performed on the quantization coefficients to generate a binary attribute bitstream.

FIG. 4B illustrates a schematic diagram of a composition framework of a G-PCC decoder. As illustrated in FIG. 4B, for the acquired binary bitstream, the geometry and attribute bitstreams in the binary bitstream are first decoded independently. Upon decoding the geometry bitstream, the geometry information of the point cloud is obtained through arithmetic decoding, octree reconstruction/predictive tree reconstruction, geometry reconstruction and coordinate inverse conversion. Upon decoding the attribute bitstream, the attribute information of the point cloud is obtained through arithmetic decoding, inverse quantization, LOD partitioning/RAHT and color inverse conversion. The point cloud data to be encoded (i.e., output point cloud) is restored based on the geometry information and attribute information.

It is to be noted that, as illustrated in FIG. 4A or FIG. 4B, the current G-PCC geometry encoding and decoding may be divided into octree-based geometry encoding and decoding (marked by a dashed box) and predictive tree-based geometry encoding and decoding (marked by a dash-dotted line box).

For the octree-based geometry encoding (Octree geometry encoding, OctGeomEnc), the OctGeomEnc includes the following. First, coordinate transform is performed on the geometry information, so that all point clouds are included in a Bounding Box. Then, quantization is performed, and the process of quantization mainly plays the role of scaling. Due to quantization and rounding, the geometry information of part of points is the same, it is determined whether to remove duplicate points based on parameters, and the process of quantization and removal of duplicate points is also referred to as voxelization process. Next, tree partitioning (e.g., octree, quadtree or binary tree) is performed on the Bounding Box continually in the order of breadth-first traversal, and the occupancy code of each node is encoded. In related art, a certain company proposed an implicit geometry partitioning method. First, the bounding box of the point cloud (2^{d}^{ₓ}, 2^{d}^{_{y}}, 2^{d}^{_{z}}) is calculated, and assuming that dₓ>d_{y}>d_{z}, correspondingly, the bounding box is a cuboid. During geometry partitioning, binary tree partitioning is performed first based on the x-axis to obtain two child nodes; binary tree partitioning continues until the condition of dₓ=d_{y}>d_{z} is met, quadtree partitioning is performed continually based on the x and y axes to obtain four child nodes; and then, when the condition of dₓ=d_{y}=d_{z} is met, octree partitioning is performed continually until the leaf node obtained through partitioning is a unit cube with a size of 1×1×1, at which the partitioning operation terminates. After that, the points in the leaf nodes are encoded to generate a binary bitstream. During the process of binary tree/quadtree/octree-based partitioning, two parameters, K and M, are introduced. Parameter K indicates the maximum number of binary tree/quadtree partitionings before octree partitioning is performed; and parameter M is used to indicate that the side length of the corresponding minimum block is 2^{M} when binary tree/quadtree partitioning is performed. At the same time, K and M must meet the conditions: assuming that dₘₐₓ=max(dₓ, d_{y}, d_{z}) and dₘᵢₙ=min(dₓ, d_{y}, d_{z}), parameter K meets the condition of K≥dₘₐₓ−dₘᵢₙ; and parameter M meets the condition of M≥dₘᵢₙ. The reason why parameters K and M meet the above conditions is that, during the current process of G-PCC geometry implicit partitioning, the priority of the partitioning manners is binary tree, quadtree and octree. Only when the block size of the node does not meet the condition of binary tree/quadtree, octree partitioning will be performed continually on the node until the minimum unit of the partitioned leaf node has a size of 1×1×1. The octree-based geometry information encoding mode may effectively encode the geometry information of the point cloud by utilizing the correlation between adjacent points in space. However, for some relatively planar nodes or nodes with planar characteristics, the coding efficiency of the geometry information of point cloud may be further improved by utilizing the planar coding mode.

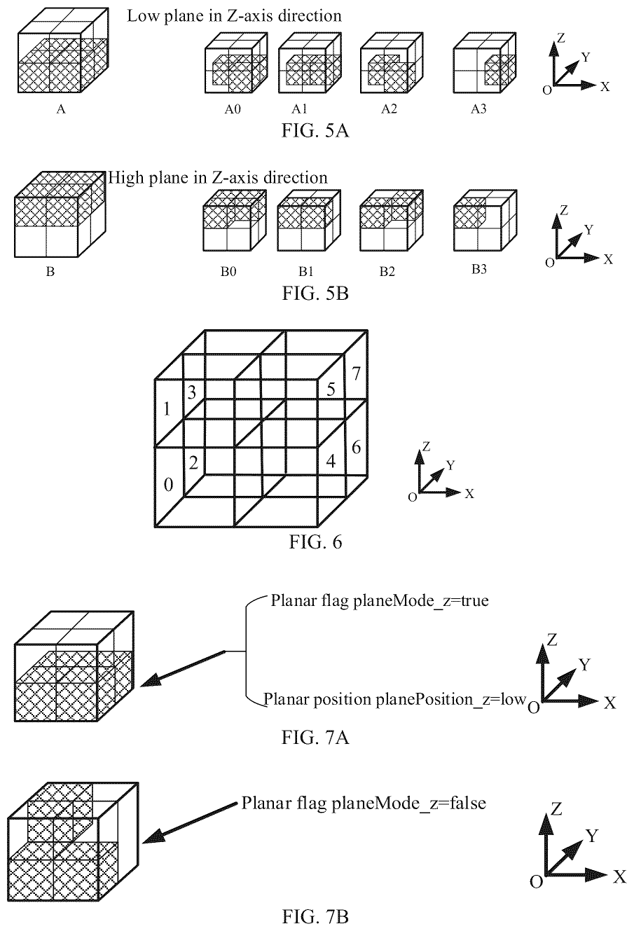

For example, FIG. 5A and FIG. 5B provide schematic diagrams of planar positions. FIG. 5A illustrates a schematic diagram of a low planar position in a Z-axis direction, and FIG. 5B illustrates a schematic diagram of a high planar position in the Z-axis direction. As illustrated in FIG. 5A, A, A0, A1, A2, and A3 here all belong to the low planar positions in the Z-axis direction. Taking A as an example, it can be seen that the four occupied child nodes of the current node are all located in the low planar positions of the current node in the Z-axis direction. Therefore, it may be considered that the current node belongs to the Z plane and is a low plane in the Z-axis direction. Similarly, as illustrated in FIG. 5B, B, B0, B1, B2, and B3 here all belong to the high planar positions in the Z-axis direction. Taking B as an example, it can be seen that the four occupied child nodes of the current node are located in the high planar positions of the current node in the Z-axis direction. Therefore, it may be considered that the current node belongs to the Z plane and is a high plane in the Z-axis direction.

Further, the efficiency of octree coding and the efficiency of planar coding are compared. FIG. 6 provides a schematic diagram of a node encoding sequence, that is, encoding is performed on nodes according to the sequence of 0, 1, 2, 3, 4, 5, 6 and 7 illustrated in FIG. 6. Here, if the octree coding manner is adopted for A in FIG. 5A, the occupancy information of the current node is represented as: 11001100. However, if the planar coding manner is adopted, one identifier needs to be encoded first to represent that the current node is a plane in the Z-axis direction; secondly, if the current node is a plane in the Z-axis direction, the planar position of the current node needs to be represented; and thirdly, only the occupancy information of the low plane nodes in the Z-axis direction needs to be encoded (that is, the occupancy information of the four child nodes 0, 2, 4 and 6). Therefore, only 6 bits need to be encoded when encoding is performed on the current node based on the planar coding manner, which can reduce representation of 2 bits compared with the octree coding of the related technology. Based on the analysis, planar coding achieves a significant improvement in coding efficiency compared with octree coding. Therefore, for an occupied node, if the planar coding manner is adopted in a certain dimension, firstly, it is necessary to represent the planar flag (PlanarMode/PlaneMode) and planar/plane position (PlanePos) information of the current node in such dimension, and then, encode the occupancy information of the current node based on the plane information of the current node. For example, FIG. 7A illustrates a schematic diagram of planar flag information. As illustrated in FIG. 7A, there is a low plane in the Z-axis direction; accordingly, the value of the planar flag information is true or 1, i.e., planarMode_z=true; and the planar position information (or referred to as plane position information) is low plane, i.e., PlanePosition_z=low. FIG. 7B illustrates another schematic diagram of planar flag information. As illustrated in FIG. 7B, there is no plane in the Z-axis direction; accordingly, the value of the plane mode information is false or 0, i.e., planarMode_z-false.

It is to be noted that, for PlaneMode_{_i}, 0 represents that the current node is not a plane in the i-axis direction, and 1 represents that the current node is a plane in the i-axis direction. If the current node is a plane in the i-axis direction, for PlanePosition_{_i}, 0 represents that the current node is a low plane in the i-axis direction, and 1 represents that the current node is a high plane in the i-axis direction. Where i represents the coordinate dimension, which may be the X-axis direction, the Y-axis direction or the Z-axis direction, so i=0, 1, 2.

However, the octree-based geometry information coding mode has an efficient compression rate only for points with correlation in space, while for points in isolated positions in the geometry space, the complexity may be significantly reduced using the direct coding model (DCM). For all nodes in the octree, the use of DCM is not represented by flag bit information, but inferred through the parent node and neighbor information of the current node. There are three ways to determine whether the current node is eligible for DCM encoding, and details are as follows.
(1) The current node has no sibling child nodes, that is, the parent node of the current node has only one child node, and the parent node of the parent node of the current node has only two occupied child nodes, that is, the current node has one neighbor node at most.
(2) The parent node of the current node has only one occupied child node (i.e., the current node); and the six neighbor nodes that share a face with the current node also belong to empty nodes.
(3) The number of sibling nodes of the current node is greater than 1.

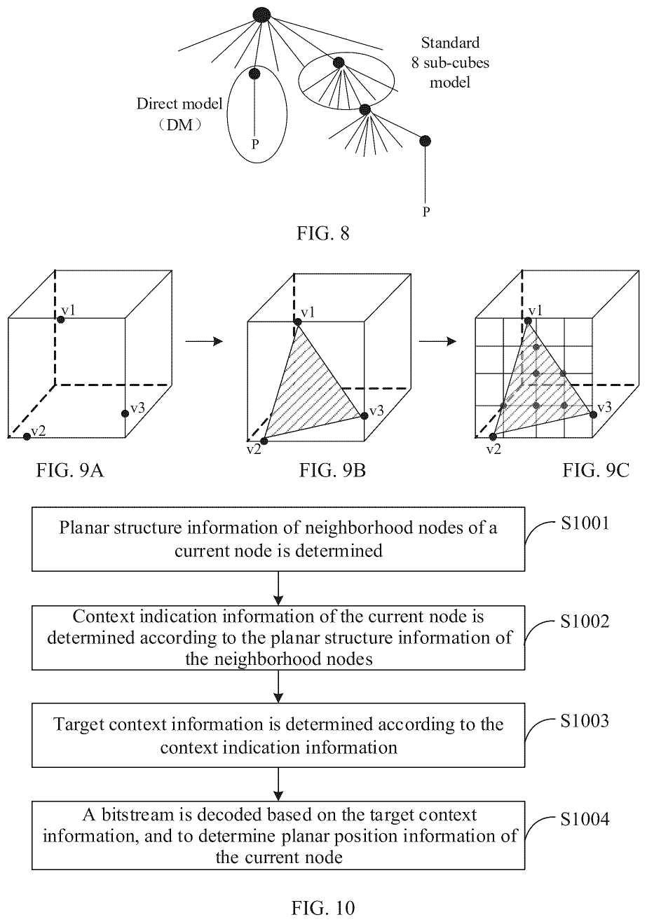

For example, FIG. 8 provides an encoding schematic diagram of infer direct coding mode (IDCM). If the current node is not eligible for DCM encoding, octree partitioning will be performed on the current node. If the current node is eligible for DCM encoding, the number of points included in the node will be further determined. When the number of points is less than a threshold (e.g., 2), DCM encoding will be performed on the node, otherwise, octree partitioning will continue to be performed on the node. When the DCM coding mode is applied, it is necessary to encode whether the current node is a real isolated point firstly, that is, IDCM_flag. When IDCM_flag is true, the current node adopts DCM encoding, otherwise, it still adopts octree coding. When the current node meets the condition for DCM encoding, it is necessary to encode the DCM coding mode of the current node. At present, there are two DCM modes, which are: (a) existing only one point (or multiple points, but they are duplicate points); and (b) containing two points. Finally, it is necessary to encode the geometry information of each point. Assuming that a side length of the node is 2^{d}, d bits are required to encode each component of the geometric coordinates of the node, and this bit information is directly encoded into the bitstream. It is to be noted here that when encoding is performed on the laser lidar point cloud, predictive coding is performed on the three dimension coordinate information by using the laser lidar acquisition parameters, thereby further improving the coding efficiency of the geometry information.

It is also to be noted that when a node is partitioned into leaf nodes, under geometry lossless encoding, the number of duplicate points in the leaf nodes needs to be encoded. Finally, the occupancy information of all nodes is encoded to generate a binary bitstream. In addition, a planar coding mode is introduced in G-PCC currently. During the process of geometry partitioning, it will be determined whether the child nodes of the current node are coplanar. If the child nodes of the current node meet the condition for coplanar, the child nodes of the current node will be represented by the plane.

For octree-based geometry decoding, before decoding the occupancy information of each node in the order of breadth-first traversal, the decoding side will first determine whether to perform planar decoding or IDCM decoding on the current node by using the reconstructed geometry information. If the current node meets the condition for planar decoding, the planar mode and planar position information of the current node will be decoded firstly, and then the occupancy information of the current node will be decoded based on the plane information. If the current node meets the condition for IDCM decoding, whether the current node is a true IDCM node will be decoded firstly. If it is a true IDCM node, the DCM decoding mode of the current node will continue to be parsed, then the number of points in the current DCM node may be obtained; and finally the geometry information of each point is decoded. For a node that does not meet the condition for either planar decoding or DCM decoding, the occupancy information of the current node will be decoded. By continuously parsing in this way, the occupancy code of each node is obtained, and the nodes are partitioned continuously in sequence until a unit cube with a size of 1×1×1 is obtained through partitioning, at which the partitioning operation terminates. The number of points included in each leaf node is obtained by parsing; and finally, the geometric reconstruction point cloud information is restored.

For triangle soup (trisoup)-based geometry information encoding, in the trisoup-based geometry information encoding framework, geometry partitioning may also be performed firstly. However, unlike binary tree/quadtree/octree-based geometry information encoding, this method does not need to partition the point cloud step by step into unit cubes with side lengths of 1×1×1, but partition the point cloud into sub-blocks until the side length of the sub-block is W. Based on the surface formed by the distribution of the point cloud in each block, at most 12 vertexes generated between the surface and the 12 edges of the block are obtained. The vertex coordinates of each block are encoded sequentially to generate a binary bitstream.

For trisoup-based point cloud geometry information reconstruction, when point cloud geometry information reconstruction is performed at the decoding side, the vertex coordinates are decoded firstly to complete triangle patch reconstruction, and the process is illustrated in FIG. 9A, FIG. 9B and FIG. 9C. There are 3 vertexes (v1, v2, v3) in the block illustrated in FIG. 9A. A triangle patch set formed by using these 3 vertexes in a certain order is called a triangle soup, or trisoup, as illustrated in FIG. 9B. Thereafter, sampling is performed on the trisoup, and the obtained sampling points are taken as the reconstructed point cloud within the block, as illustrated in FIG. 9C.

For predictive tree-based geometry encoding (Predictive geometry coding, PredGeom Tree), the PredGeom Tree includes the following. An input point cloud is sorted firstly, where the sorting manners currently adopted include disorder, Morton order, azimuth order and radial distance order. At the encoding side, the predictive tree structure is established by using two different manners, which include: KD-Tree (high delay slow mode) and low delay fast mode (laser radar calibration information utilization). When using the laser radar calibration information, each point is partitioned into different Lasers, and the predictive tree structure is constructed according to the different Lasers. Next, based on the predictive tree structure, each node in the predictive tree is traversed, prediction is performed on the geometry position information of the node by selecting different prediction modes to obtain the prediction residuals, and quantization is performed on the geometry prediction residuals using the quantization parameters. Finally, through continuous iteration, the prediction residuals of the predictive tree node position information, the predictive tree structure and the quantization parameters are encoded, to generate a binary bitstream.

For PredGeomTree, the decoding side reconstructs predictive tree structure by continuously parsing the bitstream, then obtains the quantization parameters and geometry position prediction residual information of each prediction node through parsing, performs inverse quantization on the prediction residuals to restore and obtain the reconstructed geometry position information of each node, and finally completes the geometric reconstruction at the decoding side.

After geometry encoding is completed, the geometry information needs to be reconstructed. At present, attribute encoding is mainly performed for color information. Firstly, the color information is transformed from the RGB color space to the YUV color space. Then, recoloring is performed on the point cloud using the reconstructed geometry information, so that the unencoded attribute information is corresponded to the reconstructed geometry information. During color information encoding, there are two main transform methods: one is the distance-based lifting transform that depends on LOD partitioning, and the other is the direct RAHT transform. Both methods could transform the color information from the spatial domain to the frequency domain, obtain high-frequency coefficients and low-frequency coefficients through transform, and finally perform quantization and encoding on the coefficients to generate a binary bitstream, as illustrated in FIG. 4A and FIG. 4B.

Further, when performing prediction on the attribute information using the geometry information, Morton codes may be used to perform nearest neighbor searching, and the Morton code corresponding to each point in the point cloud may be obtained from the geometric coordinates of the point. The specific method of calculating the Morton code is described as follows. For the three-dimensional coordinates whose each component is represented by a d-bits binary number, its three components may be expressed as:

$$x = {\sum }_{ℓ = 1}^{d} {2}^{d - ℓ} {x}_{ℓ} , y = {\sum }_{ℓ = 1}^{d} {2}^{d - ℓ} {y}_{ℓ} , z = {\sum }_{ℓ = 1}^{d} {2}^{d - ℓ} {z}_{ℓ} \qquad ( 1 )$$

Where [symbol] ∈{0,1} are binary numerical values corresponding to bits, from the highest ( [symbol] =1) to the lowest ( [symbol] =d), of x, y, z, respectively. For x, y, z, starting from the highest bit, [symbol] are crosswise arranged in sequence by using the Morton code M up to the lowest bit. The calculation formula of M is as follows:

$$M = {\sum }_{ℓ = 1}^{d} {2}^{3 ( d - ℓ )} ( 4 {x}_{ℓ} + 2 {y}_{ℓ} + {z}_{ℓ} ) = {\sum }_{{ℓ}^{′} = 1}^{3 d} {2}^{3 d - {ℓ}^{′}} {m}_{{ℓ}^{′}} \qquad ( 2 )$$

Where m [symbol] ∈{0,1} are values of M from the highest bit ( [symbol] =1) to the lowest bit ( [symbol] =3d). After the Morton code M of each point in the point cloud is obtained, the points in the point cloud are arranged in order of Morton code in an ascending order, and a weight value w of each point is set to 1.

It is also to be understood that for the G-PCC encoding and decoding framework, the general test conditions are as follows.
(1) There are 4 test conditions:
   Condition 1: geometry positions with limited loss, and attributes with loss;
   Condition 2: geometry positions lossless, but attributes with loss;
   Condition 3: geometry positions lossless, and attributes with limited loss; and
   Condition 4: geometry positions lossless, and attributes lossless.
(2) The general test sequence includes four categories: Cat1A, Cat1B, Cat3-fused and Cat3-frame. Cat3-frame point cloud only includes reflectance attribute information, Cat1A and Cat1B point clouds only include color attribute information, and Cat3-fused point cloud includes both color and reflectance attribute information.
(3) Technical routes: there are 2 technical routes in total, which are distinguished by the algorithm used for geometry compression.

### Technical Route 1: Octree Coding Branch

At the encoding side, the bounding box is partitioned into sub-cubes in sequence, and the non-empty (including points in the point cloud) sub-cubes continue to be partitioned until each leaf node obtained through partitioning is a unit cube with a size of 1×1×1, at which the partitioning operation terminates. In the case of geometry lossless encoding, the number of points included in the leaf node needs to be encoded, and finally the geometry octree coding is completed to generate a binary bitstream.

At the decoding side, the decoding side obtains the occupancy code of each node by continuously parsing in the order of breadth-first traversal, and partitions the nodes continuously in sequence until a unit cube 1×1×1 is obtained, at which the partitioning operation terminates. In the case of geometry lossless decoding, it is necessary to parse and obtain the number of points included in each leaf node, and finally the geometric reconstruction point cloud information is restored.

### Technical Route 2: Predictive Tree Coding Branch

At the encoding side, the predictive tree structure is established by using two different ways, which include: KD-Tree (high delay slow mode)-based and laser radar calibration information utilization (low delay fast mode). Using the laser radar calibration information, each point may be partitioned into different Lasers, and the predictive tree structure may be constructed according to the different Lasers. Next, based on the predictive tree structure, each node in the predictive tree is traversed, prediction is performed on the geometry position information of the node by selecting different prediction modes to obtain the prediction residuals, and quantization is performed on the geometry prediction residuals using the quantization parameters. Finally, through continuous iteration, the prediction residuals of the predictive tree node position information, the predictive tree structure and the quantization parameters are encoded, to generate a binary bitstream.

At the decoding side, the decoding side reconstructs predictive tree structure by continuously parsing the bitstream, then obtains the quantization parameters and geometry position prediction residual information of each prediction node through parsing, performs inverse quantization on the prediction residuals to restore the reconstructed geometry position information of each node, and finally completes the geometric reconstruction at the decoding side.

In brief, when the current node satisfies the condition for planar coding, in the related art, predictive encoding and decoding is performed on the planar position information of the current node only based on partial prior reference information without considering the planar information of the neighborhood nodes. Thus, when predictive encoding and decoding is performed on the planar position information of the current node, geometric coding efficiency of the current node is reduced due to incomplete consideration.

Based on this, the embodiments of the present disclosure provide an encoding and decoding method. At the encoding side, planar structure information of neighborhood nodes of a current node is determined; context indication information of the current node is determined according to the planar structure information of the neighborhood nodes; target context information is determined according to the context indication information; planar position information of the current node is determined, and the planar position information of the current node is encoded based on the target context information, and obtained encoded bits are signaled (written) into a bitstream. At the decoding side, planar structure information of neighborhood nodes of a current node is determined; context indication information of the current node is determined according to the planar structure information of the neighborhood nodes; target context information is determined according to the context indication information; a bitstream is decoded based on the target context information to determine the planar position information of the current node. In this way, during the process of encoding and decoding the planar position information of the current node by using the target context information, the target context information may be determined through considering the planar structure information of the neighborhood nodes of the current node; moreover, through considering the correlation between the planar structure information of the neighborhood nodes, the geometry information coding efficiency of the point cloud is effectively improved, thereby improving the encoding and decoding performance of the point cloud.

The embodiments of the present disclosure will be described in detail below with reference to the drawings.

In an embodiment of the present disclosure, referring to FIG. 10, a flowchart of a decoding method provided in the embodiments of the present disclosure is illustrated. As illustrated in FIG. 10, the method may include the following.

In S1001, planar structure information of neighborhood nodes of a current node is determined.

It is to be noted that the decoding method in the embodiments of the present disclosure is applied to a decoder. In addition, the decoding method may specifically refer to a point cloud geometry decoding method, more specifically, refer to a context information determination method based on a point cloud planar coding mode, and then the planar position information of the current node is decoded according to the determined target context information.

It is also to be noted that in a point cloud, points may refer to all points in the point cloud, or may refer to a part of points in the point cloud, and these points are relatively concentrated in space. Here, the current node specifically refers to a node currently to be decoded in the point cloud.

In the embodiments of the present disclosure, it is first necessary to determine the neighborhood nodes of the current node. The neighborhood nodes may also be referred to as the neighboring nodes adjacent to the current node. In some embodiments, the neighborhood nodes may include at least one of: at least one co-planar node sharing a face with the current node, at least one co-edge node sharing an edge with the current node, or at least one co-vertex node sharing a vertex with the current node.

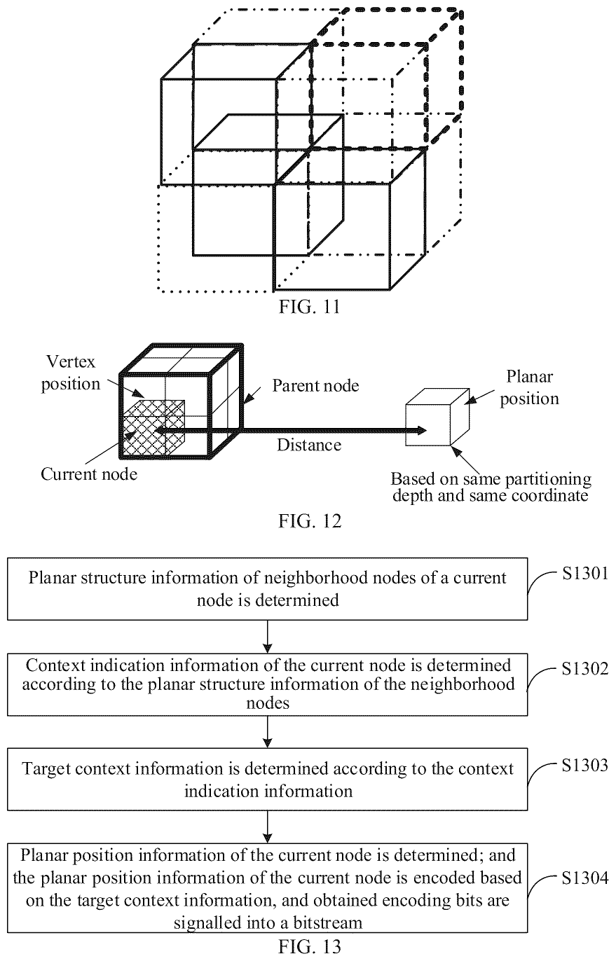

Specifically, FIG. 11 illustrates a schematic diagram of position relationship between a current node and neighborhood nodes provided by the embodiments of the present disclosure. As illustrated in FIG. 11, a node represented by bold dashed line represents the current node, nodes represented by dash-dotted line represent three neighborhood nodes sharing a face with the current node (i.e., co-planar neighborhood nodes, which may be simply referred to as “co-planar nodes”), nodes represented by solid line represent three neighborhood nodes sharing an edge with the current node (i.e., co-edge neighborhood nodes, which may be simply referred to as “co-edge nodes”), and a node represented by dots represents a neighborhood node sharing a vertex with the current node (i.e., co-vertex neighborhood node, which may be simply referred to as “co-vertex node”). Because according to the order of point cloud decoding, when occupancy information of the current node is decoded, occupancy information of seven neighborhood nodes that are sharing a face, an edge and a vertex with the current node may be obtained, and then the planar structure information of these neighborhood nodes may be determined.

It is also to be noted that, in the embodiments of the present disclosure, the neighborhood nodes of the current node may include 6 co-planar nodes, 12 co-edge nodes and 8 co-vertex nodes. Here, the neighborhood nodes may be only co-planar nodes, or may be only co-edge nodes, or may be co-planar nodes and co-edge nodes, or may be co-planar nodes, co-edge nodes and co-vertex nodes, or may be a larger reference neighborhood range, which is not specifically limited in the embodiments of the present disclosure.

In addition, considering the balance between encoding efficiency, time complexity, memory occupancy rate or the like, only seven neighborhood nodes may be considered here, which specifically refer to three co-planar nodes, three co-edge nodes and one co-vertex node adjacent to the left, front and below of the current node as illustrated in FIG. 11.

In this way, after the occupancy information of the neighborhood nodes is determined, the planar structure information of the neighborhood nodes may be determined by using the occupancy information of the neighborhood nodes, so as to predict and decode the planar position information of the current node.

In S1002, context indication information of the current node is determined according to the planar structure information of the neighborhood nodes.

It is to be noted that, in the embodiments of the present disclosure, the context indication information of the current node may include first context indication information of the current node and second context indication information of the current node. The calculation of the context indication information is performed according to the planar structure information (e.g., planar flag information and/or planar position information) of the neighborhood nodes. The calculation method is not limited, and there is no specific limitation on how to perform the calculation.

In a possible implementation, the operation that the context indication information of the current node is determined according to the planar structure information of the neighborhood nodes may include:
determining planar structure information of first-type neighborhood nodes and planar structure information of second-type neighborhood nodes according to the planar structure information of the neighborhood nodes;
determining the first context indication information of the current node according to the planar structure information of the first-type neighborhood nodes; and
determining the second context indication information of the current node according to the planar structure information of the second-type neighborhood nodes.

In the embodiments of the present disclosure, the neighborhood nodes may include: three co-planar nodes sharing a face with the current node, three co-edge nodes sharing an edge with the current node, and one co-vertex node sharing a vertex with the current node, which are the seven neighborhood nodes illustrated in FIG. 11, specifically. Here, the seven neighborhood nodes may be classified as the first-type neighborhood nodes and the second-type neighborhood nodes. Specifically, the first-type neighborhood nodes only include three co-planar nodes, and the second-type neighborhood nodes only include three co-edge nodes and one co-vertex node. Then, the first context indication information of the current node is calculated by using the planar structure information of the first-type neighborhood nodes, and the second context indication information of the current node is calculated by using the planar structure information of the second-type neighborhood nodes.

In a specific embodiment, in response to the first-type neighborhood nodes including three co-planar nodes sharing a face with the current node, determining the planar structure information of the first-type neighborhood nodes may include:
determining occupancy information of the three co-planar nodes;
determining planar flag information of the three co-planar nodes and planar position information of the three co-planar nodes according to the occupancy information of the three co-planar nodes; and
composing the planar structure information of the first-type neighborhood nodes according to the planar flag information of the three co-planar nodes and the planar position information of the three co-planar nodes.

Specifically, taking predictive decoding of the planar position information in the X-axis direction as an example, assuming that the occupancy information of the three co-planar nodes is coPlanarLeft, coPlanarFront and coPlanarBelow, the planar structure information of the three co-planar nodes (including planar flag (planarMode) information and planar position (PlanePos) information) is first calculated by using the occupancy information of the three co-planar nodes. Here, PlaneMode and PlanePos are calculated as follows:

$$uint 8 \_t plane 0 = 0 \text{;}$$

$$plane 0 \vert = ! ! ( occupancy \& 0 x 0 f ) << 0 ;$$

$$plane 0 \vert = ! ! ( occupancy \& 0 x 33 ) << 1 ;$$

$$plane 0 \vert = ! ! ( occupancy \& 0 x 55 ) << 2 ;$$

$$uin t 8 \_t plane 1 = 0 ;$$

$$plane 1 \vert = ! ! ( occupancy \& 0 xf 0 ) << 0 ;$$

$$plane 1 \vert = ! ! ( occupancy \& 0 xcc ) << 1 ;$$

$$plane 1 \vert = ! ! ( occupancy \& 0 xaa ) << 2 ;$$

$$// Only planar if a single plane normal to an axis is occupied$$

$$planarMode = plane 0 ⋀ plane 1 ;$$

$$PlanePos = planarMode \& plane 1 ;$$

In this way, the planar structure information of the first-type neighborhood nodes is calculated by using the occupancy information of the three co-planar nodes, in which the planar structure information is: coPlanarLeftPlaneMode, coPlanarLeftPlanePos, coPlanarFrontPlaneMode, coPlanarFrontPlanePos, coPlanarBelowPlaneMode and coPlanarBelowPlanePos.

Further, determining the first context indication information of the current node according to the planar structure information of the first-type neighborhood nodes may include: determining the first context indication information of the current node according to the planar flag information of the three co-planar nodes and the planar position information of the three co-planar nodes.

It is also to be noted that, assuming that the first context indication information of the current node may be represented by Ctx1, after the planar structure information of the three co-planar nodes is determined, Ctx1 may be calculated by using the planar structure information of the three co-planar nodes, as follows:

$$Const int mask = 1 << axisIdx ( axisIdx = 0 ( x ) , 1 ( y ) , 2 ( z ) ) \qquad ( 3 )$$

$$Ctx 1 = ! ! ( coPlanarLeftPlanePos \& mask ) << 5 \vert$$

$$! ! ( coPlanarFrontPlanePos \& mask ) << 4 \vert$$

$$! ! ( coPlanarBelowPlanePos \& mask ) << 3 \vert$$

$$! ! ( coPlanarLeftPlaneMode \& mask ) << 2 \vert$$

$$! ! ( coPlanarFrontPlaneMode \& mask ) << 1 \vert$$

$$! ! ( coPlanarBelowPlaneMode \& mask )$$

In another specific embodiment, in response to the second-type neighborhood nodes including three co-edge nodes sharing an edge with the current node and one co-vertex node sharing a vertex with the current node, determining the planar structure information of the second-type neighborhood nodes may include:
determining occupancy information of the three co-edge nodes and occupancy information of the one co-vertex node;
determining planar flag information of the three co-edge nodes and planar position information of the three co-edge nodes according to the occupancy information of the three co-edge nodes, and determining planar flag information of the one co-vertex node and planar position information of the one co-vertex node according to the occupancy information of the one co-vertex node; and
composing the planar structure information of the second-type neighborhood nodes according to the planar flag information of the three co-edge nodes, the planar flag information of the one co-vertex node, the planar position information of the three co-edge nodes and the planar position information of the one co-vertex node.

It is to be noted that, assuming that the occupancy information of the three co-edge nodes and the occupancy information of the one co-vertex node are coEdgerLeft, coEdgerFront, coEdgerBelow and coVertex, respectively, the planar structure information of the second-type neighborhood nodes is first calculated by using the occupancy information of the three co-edge nodes and the occupancy information of the one co-vertex node, in which the planar structure information is coEdgerLeftPlaneMode, coEdgerLeftPlanePos, coEdgerFrontPlaneMode, coEdgerFrontPlanePos, coEdgerBelowPlaneMode, coEdgerBelowPlanePos, co VertexPlaneMode, and co VertexPlanePos, respectively.

Further, determining the second context indication information of the current node according to the planar structure information of the second-type neighborhood nodes may include: determining the second context indication information of the current node according to the planar flag information of the three co-edge nodes, the planar flag information of the one co-vertex node, the planar position information of the three co-edge nodes and the planar position information of the one co-vertex node.

It is also to be noted that, assuming that the second context indication information of the current node may be represented by Ctx2, after the planar structure information of three co-edge nodes and one co-vertex node is determined, Ctx2 may be calculated by using the planar structure information of the three co-edge nodes and one co-vertex node, as follows:

$$Ctx 2 = ! ! ( coEdgerLeftPlanePos \& mask ) << 7 \vert \qquad ( 4 )$$

$$! ! ( coEdgerFrontPlanePos \& mask ) << 6 \vert$$

$$! ! ( coEdgerBelowPlanePos \& mask ) << 5 \vert$$

$$! ! ( coVertexPlanePos \& mask ) << 4 \vert$$

$$! ! ( coEdgerLeftPlaneMode \& mask ) << 3 \vert$$

$$! ! ( coEdgerFrontPlaneMode \& mask ) << 2 \vert$$

$$! ! ( coEdgerBelowPlaneMode \& mask ) << 1 \vert$$

$$! ! ( coVertexPlaneMode \& mask )$$

In the embodiments of the present disclosure, “<<” represents a left shift operator, for example, “<<n” represents a left shift of n bits, which is multiplied by 2ⁿ in a multiplication operation. “!!” is usually used for type determination, which represents double negation, that is, the negated value is negated again. “|” represents a bitwise operator, specifically bitwise OR here. “&” represents a bitwise operator, specifically bitwise AND here; for “a|=b”, it represents a=a|b, that is, the value after bitwise OR on a and b is assigned to a.

In another possible implementation, the operation that the context indication information of the current node is determined according to the planar structure information of the neighborhood nodes may include:
determining first-type planar structure information of the neighborhood nodes and second-type planar structure information of the neighborhood nodes according to the planar structure information of the neighborhood nodes;
determining first context indication information of the current node according to the first-type planar structure information of the neighborhood nodes; and
determining second context indication information of the current node according to the second-type planar structure information of the neighborhood nodes.

It is to be noted that in the embodiments of the present disclosure, the neighborhood nodes may include: three co-planar nodes sharing a face with the current node, three co-edge nodes sharing an edge with the current node, and one co-vertex node sharing a vertex with the current node, which are the seven neighborhood nodes illustrated in FIG. 11, specifically. Specifically, the first context indication information may be calculated by using the planar position information of the seven neighborhood nodes, and the second context indication information may be calculated by using the planar flag information of the seven neighborhood nodes.

In a specific embodiment, in response to the neighborhood nodes including three co-planar nodes sharing a face with the current node, three co-edge nodes sharing an edge with the current node and one co-vertex node sharing a vertex with the current node, determining the first-type planar structure information of the neighborhood nodes may include:
determining respective occupancy information of the three co-planar nodes, the three co-edge nodes and the one co-vertex node;
determining, according to the respective occupancy information of the three co-planar nodes, the three co-edge nodes and the one co-vertex node, planar position information of the three co-planar nodes, planar position information of the three co-edge nodes and planar position information of the one co-vertex node; and
composing the first-type planar structure information of the neighborhood nodes according to the planar position information of the three co-planar nodes, the planar position information of the three co-edge nodes and the planar position information of the one co-vertex node.

Further, determining the first context indication information of the current node according to the first-type planar structure information of the neighborhood nodes may include: determining the first context indication information of the current node according to the planar position information of the three co-planar nodes, the planar position information of the three co-edge nodes and the planar position information of the one co-vertex node.

In the embodiments of the present disclosure, the first-type planar structure information of the neighborhood nodes may include: coPlanarLeftPlanePos, coPlanarFrontPlanePos, coPlanarBelowPlanePos, coEdgerLeftPlanePos, coEdgerFrontPlanePos, coEdgerBelowPlanePos, and co VertexPlanePos.

In this way, assuming that the first context indication information of the current node may be represented by Ctx1, after the planar position information of the seven neighborhood nodes is determined, Ctx1 may be calculated by using the planar position information of the seven neighborhood nodes, as follows:

$$Const int mask = 1 << axisIdx ( axisIdx = 0 ( x ) , 1 ( y ) , 2 ( z ) ) \qquad ( 5 )$$

$$Ctx 1 = ! ! ( coPlanarLeftPlanePos \& mask ) << 6 \vert$$

$$! ! ( coPlanarFrontPlanePos \& mask ) << 5 \vert$$

$$! ! ( coPlanarBelowPlanePos \& mask ) << 4 \vert$$

$$! ! ( coEdgerLeftPlanePos \& mask ) << 3 \vert$$

$$! ! ( coEdgerFrontPlanePos \& mask ) << 2 \vert$$

$$! ! ( coEdgerBelowPlanePos \& mask ) << 1 \vert$$

$$! ! ( coPlanarBelowPlaneMode \& mask )$$

In another specific embodiment, in response to the neighborhood nodes including three co-planar nodes sharing a face with the current node, three co-edge nodes sharing an edge with the current node and one co-vertex node sharing a vertex with the current node, determining the second-type planar structure information of the neighborhood nodes may include:
determining respective occupancy information of the three co-planar nodes, the three co-edge nodes and the one co-vertex node;
determining, according to the respective occupancy information of the three co-planar nodes, the three co-edge nodes and the one co-vertex node, planar flag information of the three co-planar nodes, planar flag information of the three co-edge nodes and planar flag information of the one co-vertex node; and
composing the second-type planar structure information of the neighborhood nodes according to the planar flag information of the three co-planar nodes, the planar flag information of the three co-edge nodes and the planar flag information of the one co-vertex node.

Further, determining the second context indication information of the current node according to the second-type planar structure information of the neighborhood nodes may include: determining the second context indication information of the current node according to the planar flag information of the three co-planar nodes, the planar flag information of the three co-edge nodes and the planar flag information of the one co-vertex node.

In the embodiments of the present disclosure, the second-type planar structure information of the neighborhood nodes may include: coPlanarLeftPlaneMode, coPlanarFrontPlaneMode, coPlanarBelowPlaneMode, coEdgerLeftPlaneMode, coEdgerFrontPlaneMode, coEdgerBelowPlaneMode, and co VertexPlaneMode.

In this way, assuming that the second context indication information of the current node may be represented by Ctx2, after the planar flag information of the seven neighborhood nodes is determined, Ctx2 may be calculated by using the planar flag information of the seven neighborhood nodes, as follows:

$$Ctx 2 = ! ! ( coPlanarLeftPlanarMode \& mask ) << 6 \vert \qquad ( 6 )$$

$$! ! ( coPlanarFrontPlanarMode \& mask ) << 5 \vert$$

$$! ! ( coPlanarBelowPlanarMode \& mask ) << 4 \vert$$

$$! ! ( coEdgerLeftPlanarMode \& mask ) << 3 \vert$$

$$! ! ( coEdgerFrontPlanarMode \& mask ) << 2 \vert$$

$$! ! ( coEdgerBelowPlanarMode \& mask ) << 1 \vert$$

$$! ! ( coVertexPlanarMode \& mask )$$

That is, in the above implementation, Ctx1 may be calculated by using the planar flag information and the planar position information of the three co-planar nodes, and Ctx2 may be calculated by using the planar flag information and the planar position information of the three co-edge nodes and the planar flag information and the planar position information of the one co-vertex node. Alternatively, Ctx1 may be calculated by using the planar position information of the seven neighborhood nodes (i.e., three co-planar nodes, three co-edge nodes and one co-vertex node), and Ctx2 may be calculated by using the planar flag information of the seven neighborhood nodes (i.e., three co-planar nodes, three co-edge nodes and one co-vertex node). Here, only two calculating methods of obtaining Ctx1 and Ctx2 by using the planar structure information of the neighborhood nodes are provided, but the calculation of Ctx1 and Ctx2 is not limited by the embodiments of the present disclosure. For example, in the embodiments of the present disclosure, Ctx1 and Ctx2 may be calculated (or reckoned) by using the occupancy information of the neighborhood nodes, and there is no specific limitation on how to perform the calculation.

In S1003, target context information is determined according to the context indication information.

In S1004, a bitstream is decoded based on the target context information to determine planar position information of the current node.

It is to be noted that in the embodiments of the present disclosure, the target context information needs to be determined first, and then the planar position information of the current node may be decoded by using the target context information. In some embodiments, the operation that the target context information is determined according to the context indication information may include:
determining the first context indication information of the current node and the second context indication information of the current node; and
determining the target context information according to the first context indication information and the second context indication information.

That is, after Ctx1 and Ctx2 are calculated by using the planar structure information of the neighborhood nodes, the target context information may be determined according to Ctx1 and Ctx2. Further, in the embodiments of the present disclosure, context mapping processing may further be performed on Ctx1 and Ctx2 to determine the target context information. Therefore, in some embodiments, determining the target context information according to the first context indication information and the second context indication information may include:
performing context mapping processing according to the first context indication information and the second context indication information, to obtain new context information; and
   determining the target context information according to the new context information.

It is also to be noted that in the embodiments of the present disclosure, Ctx1 and Ctx2 may be directly calculated by performing simple AND or OR operation using the planar structure information of multiple neighborhood nodes such as co-planar, co-edge and co-vertex nodes, and finally the target context information is determined. In addition, in the embodiments of the present disclosure, the target context information ultimately used for decoding is not limited. For example, the new context information may be obtained by performing mapping on Ctx1 and Ctx2 using methods such as spatial rotation without deformation, or context mapping, so that the target context information is determined, which is not specifically limited here.

In some embodiments, the operation that the target context information is determined according to the context indication information may include:
determining reference context information of the current node; and
determining the target context information according to the first context indication information, the second context indication information and the reference context information.

Further, for the existing reference context information, in some embodiments, determining the reference context information of the current node includes at least one of:
1) performing prediction according to occupancy information of the neighborhood nodes to determine a prediction value of the planar position information of the current node, where the prediction value includes one of: low plane, high plane, or unpredictable;
2) determining a spatial distance between a node at a same partitioning depth and a same coordinate as the current node and the current node, where the spatial distance includes one of: near distance or far distance;
3) determining whether a node at a same partitioning depth and a same coordinate as the current node is a plane, and in response to the node being a plane, determining a planar position of the node; or
4) determining coordinate dimension information of the current node.

It is to be noted that in the embodiments of the present disclosure, after the spatial distance between the node at the same partition depth and the same coordinate as the current node and the current node is determined, if the spatial distance is less than a preset distance threshold, the spatial distance may be determined to be the near distance; or if the spatial distance is greater than the preset distance threshold, the spatial distance may be determined to be the far distance.

Specifically, FIG. 12 is a schematic diagram of a neighborhood node at a same partition depth and a same coordinate provided by the embodiments of the present disclosure. As illustrated in FIG. 12, the bold large cube represents the parent node, the small cube filled with grid inside the parent node represents the current node, where a vertex position of the current node is shown; and the small cube filled with white represents the neighborhood node that is at the same partitioning depth and the same coordinate. The distance between the current node and the neighborhood node is the spatial distance, which may be determined as “near distance” or “far distance”. In addition, if the neighborhood node is a plane, the planar position of the neighborhood node is also required.

As such, the target context information ultimately used for the planar position information may be as follows:
(a) the planar position information of the current node being obtained as three elements through predicting by using the occupancy information of the neighborhood node: predicted to be low plane, predicted to be high plane, or unpredictable;
(b) the spatial distance between the node at the same partitioning depth and the same coordinate as the current node and the current node: “near distance” or “far distance”;
(c) in response to the node at the same partitioning depth and the same coordinate as the current node being a plane, the planar position of the node being determined;
(d) the coordinate dimension of the current node (i=0, 1, 2);
(e) Ctx1, for example, which is calculated by using the planar structure information of three co-planar nodes; or
(f) Ctx2, for example, which is calculated by using the planar structure information of three co-edge nodes and the planar structure information of one co-vertex node.

That is, in the embodiments of the present disclosure, the planar structure information of the neighborhood nodes is determined by using the occupancy information of the neighborhood nodes as illustrated in FIG. 11; then the context Ctx1 and Ctx2 of the planar position information of the current node is calculated by using the planar structure information of the neighborhood nodes, and finally decoding processing is performed on the planar position information of the current node by using Ctx1, Ctx2 and the existing reference context information.

The present embodiment provides a decoding method, in which the planar structure information of the neighborhood nodes of the current node is determined; the context indication information of the current node is determined according to the planar structure information of the neighborhood nodes; the target context information is determined according to the context indication information; and the bitstream is decoded based on the target context information to determine planar position information of the current node. In this way, during the process of decoding the planar position information of the current node by using the target context information, the target context information may be determined through considering the planar structure information of the neighborhood nodes of the current node; moreover, through considering the correlation between the planar structure information of the neighborhood nodes, the geometry information coding efficiency of the point cloud can be effectively improved, thereby improving the encoding and decoding performance of the point cloud.

In another embodiment of the present disclosure, referring to FIG. 13, a flowchart of an encoding method provided by the embodiments of the present disclosure is illustrated. As illustrated in FIG. 13, the method may include the following.

In S1301, planar structure information of neighborhood nodes of a current node is determined.

It is to be noted that the encoding method in the embodiments of the present disclosure is applied to an encoder. In addition, the encoding method may specifically refer to a point cloud geometry encoding method, more specifically, refer to a context information determination method based on a point cloud planar coding mode, and then the planar position information of the current node is encoded according to the determined target context information.

It is also to be noted that in a point cloud, points may refer to all points in the point cloud, or may refer to a part of points in the point cloud, and these points are relatively concentrated in space. Here, the current node specifically refers to a node currently to be encoded in the point cloud.

In the embodiments of the present disclosure, it is first necessary to determine the neighborhood nodes of the current node. The neighborhood nodes may also be referred to as the neighboring nodes adjacent to the current node. In some embodiments, the neighborhood nodes may include at least one of: at least one co-planar node sharing a face with the current node, at least one co-edge node sharing an edge with the current node, or at least one co-vertex node sharing a vertex with the current node.

In a specific embodiment, the neighborhood nodes of the current node may include 6 co-planar nodes, 12 co-edge nodes and 8 co-vertex nodes. Here, the neighborhood nodes may be only co-planar nodes, or may be only co-edge nodes, or may be co-planar nodes and co-edge nodes, or may be co-planar nodes, co-edge nodes and co-vertex nodes, or may be a larger reference neighborhood range, which is not specifically limited in the embodiments of the present disclosure.

In addition, considering the balance between encoding efficiency, time complexity, memory occupancy rate or the like, only seven neighborhood nodes may be considered here, which specifically refer to three co-planar nodes, three co-edge nodes and one co-vertex node adjacent to the left, front and below of the current node as illustrated in FIG. 11.

In this way, according to the order of point cloud encoding, when occupancy information of the current node is encoded, occupancy information of the seven neighborhood nodes that are sharing a face, an edge and a vertex with the current node may be obtained, and then the planar structure information of these neighborhood nodes may be determined, so as to perform predictive encoding on the planar position information of the current node.

In S1302, context indication information of the current node is determined according to the planar structure information of the neighborhood nodes.

It is to be noted that, in the embodiments of the present disclosure, the context indication information of the current node may include first context indication information of the current node and second context indication information of the current node. The calculation of the context indication information is performed according to the planar structure information (e.g., planar flag information and/or planar position information) of the neighborhood nodes. The calculation method is not limited, and there is no specific limitation on how to perform the calculation.

In a possible implementation, the operation that the context indication information of the current node is determined according to the planar structure information of the neighborhood nodes may include:
determining planar structure information of first-type neighborhood nodes and planar structure information of second-type neighborhood nodes according to the planar structure information of the neighborhood nodes;
determining the first context indication information of the current node according to the planar structure information of the first-type neighborhood nodes; and
determining the second context indication information of the current node according to the planar structure information of the second-type neighborhood nodes.

In the embodiments of the present disclosure, taking the seven neighborhood nodes illustrated in FIG. 11 as an example, the seven neighborhood nodes may be classified as the first-type neighborhood nodes and the second-type neighborhood nodes. Specifically, the first-type neighborhood nodes only include three co-planar nodes, and the second-type neighborhood nodes only include three co-edge nodes and one co-vertex node. Then, the first context indication information of the current node is calculated by using the planar structure information of the first-type neighborhood nodes, and the second context indication information of the current node is calculated by using the planar structure information of the second-type neighborhood nodes.

In a specific embodiment, in response to the first-type neighborhood nodes including three co-planar nodes sharing a face with the current node, determining the planar structure information of the first-type neighborhood nodes may include:
determining occupancy information of the three co-planar nodes;
determining planar flag information of the three co-planar nodes and planar position information of the three co-planar nodes according to the occupancy information of the three co-planar nodes; and
composing the planar structure information of the first-type neighborhood nodes according to the planar flag information of the three co-planar nodes and the planar position information of the three co-planar nodes.

Further, determining the first context indication information of the current node according to the planar structure information of the first-type neighborhood nodes may include: determining the first context indication information of the current node according to the planar flag information of the three co-planar nodes and the planar position information of the three co-planar nodes.

In the embodiments of the present disclosure, the planar structure information of the first-type neighborhood nodes is calculated by using the occupancy information of the three co-planar nodes, in which the planar structure information is: coPlanarLeftPlaneMode, coPlanarFrontPlaneMode, coPlanarLeftPlanePos, coPlanarFrontPlanePos, coPlanarBelowPlaneMode and coPlanarBelowPlanePos, respectively. Then, the first context indication information of the current node (represented by Ctx1) is calculated by using the planar structure information of these neighborhood nodes. The calculation of Ctx1 may refer to the calculation process described at the decoding side, which is specifically shown in formula (3) and will not be described in detail here.

In another specific embodiment, in response to the second-type neighborhood nodes including three co-edge nodes sharing an edge with the current node and one co-vertex node sharing a vertex with the current node, determining the planar structure information of the second-type neighborhood nodes may include:
determining occupancy information of the three co-edge nodes and occupancy information of the one co-vertex node;
determining planar flag information of the three co-edge nodes and planar position information of the three co-edge nodes according to the occupancy information of the three co-edge nodes, and determining planar flag information of the one co-vertex node and planar position information of the one co-vertex node according to the occupancy information of the one co-vertex node; and
composing the planar structure information of the second-type neighborhood nodes according to the planar flag information of the three co-edge nodes, the planar flag information of the one co-vertex node, the planar position information of the three co-edge nodes and the planar position information of the one co-vertex node.

Further, determining the second context indication information of the current node according to the planar structure information of the second-type neighborhood nodes may include: determining the second context indication information of the current node according to the planar flag information of the three co-edge nodes, the planar flag information of the one co-vertex node, the planar position information of the three co-edge nodes and the planar position information of the one co-vertex node.

In the embodiments of the present disclosure, the planar structure information of the second-type neighborhood nodes is calculated by using the occupancy information of the three co-edge nodes and the one co-vertex node, in which the planar structure information is: coEdgerLeftPlaneMode, coEdgerLeftPlanePos, coEdgerFrontPlaneMode, coEdgerFrontPlanePos, coEdgerBelowPlaneMode, coEdgerBelowPlanePos, co VertexPlaneMode and co VertexPlanePos, respectively. Then, the second context indication information of the current node (represented by Ctx2) is calculated by using the planar structure information of these neighborhood nodes. The calculation of Ctx2 may refer to the calculation process described at the decoding side, which is specifically shown in formula (4) and will not be described in detail here.

In another possible implementation, the operation that the context indication information of the current node is determined according to the planar structure information of the neighborhood nodes includes:
determining first-type planar structure information of the neighborhood nodes and second-type planar structure information of the neighborhood nodes according to the planar structure information of the neighborhood nodes;
determining first context indication information of the current node according to the first-type planar structure information of the neighborhood nodes; and
determining second context indication information of the current node according to the second-type planar structure information of the neighborhood nodes.

In the embodiments of the present disclosure, still taking the seven neighborhood nodes illustrated in FIG. 11 as an example, specifically, the first context indication information may be calculated by using the planar position information of the seven neighborhood nodes, and the second context indication information may be calculated by using the planar flag information of the seven neighborhood nodes.

In a specific embodiment, in response to the neighborhood nodes including three co-planar nodes sharing a face with the current node, three co-edge nodes sharing an edge with the current node and one co-vertex node sharing a vertex with the current node, determining the first-type planar structure information of the neighborhood nodes may include:
determining respective occupancy information of the three co-planar nodes, the three co-edge nodes and the one co-vertex node;
determining, according to the respective occupancy information of the three co-planar nodes, the three co-edge nodes and the one co-vertex node, planar position information of the three co-planar nodes, planar position information of the three co-edge nodes and planar position information of the one co-vertex node; and
composing the first-type planar structure information of the neighborhood nodes according to the planar position information of the three co-planar nodes, the planar position information of the three co-edge nodes and the planar position information of the one co-vertex node.

Further, determining the first context indication information of the current node according to the first-type planar structure information of the neighborhood nodes may include: determining the first context indication information of the current node according to the planar position information of the three co-planar nodes, the planar position information of the three co-edge nodes and the planar position information of the one co-vertex node.

In the embodiments of the present disclosure, the planar position information of the three co-planar nodes, the three co-edge nodes and the one co-vertex node is first determined, in which the planar position information is: coPlanarLeftPlanePos, coPlanarFrontPlanePos, coPlanarBelowPlanePos, coEdgerLeftPlanePos, coEdgerFrontPlanePos, coEdgerBelowPlanePos and co VertexPlanePos, respectively. Then, the first context indication information of the current node (represented by Ctx1) is calculated by using the planar position information of the seven neighborhood nodes. The calculation of Ctx1 may refer to the calculation process described at the decoding side, which is specifically shown in formula (5) and will not be described in detail here.

In another specific embodiment, in response to the neighborhood nodes including three co-planar nodes sharing a face with the current node, three co-edge nodes sharing an edge with the current node and one co-vertex node sharing a vertex with the current node, determining the second-type planar structure information of the neighborhood nodes may include:
determining respective occupancy information of the three co-planar nodes, the three co-edge nodes and the one co-vertex node;
determining, according to the respective occupancy information of the three co-planar nodes, the three co-edge nodes and the one co-vertex node, planar flag information of the three co-planar nodes, planar flag information of the three co-edge nodes and planar flag information of the one co-vertex node; and
composing the second-type planar structure information of the neighborhood nodes according to the planar flag information of the three co-planar nodes, the planar flag information of the three co-edge nodes and the planar flag information of the one co-vertex node.

Further, determining the second context indication information of the current node according to the second-type planar structure information of the neighborhood nodes may include: determining the second context indication information of the current node according to the planar flag information of the three co-planar nodes, the planar flag information of the three co-edge nodes and the planar flag information of the one co-vertex node.

In the embodiments of the present disclosure, the planar flag information of the three co-planar nodes, the three co-edge nodes and the one co-vertex node is first determined, in which the planar flag information is: coPlanarLeftPlaneMode, coPlanarFrontPlaneMode, coPlanarBelowPlaneMode, coEdgerLeftPlaneMode, coEdgerFrontPlaneMode, coEdgerBelowPlaneMode and coVertexPlaneMode, respectively. Then, the second context indication information of the current node (represented by Ctx2) is calculated by using the planar flag information of the seven neighborhood nodes. The calculation of Ctx2 may refer to the calculation process described at the decoding side, which is specifically shown in formula (6) and will not be described in detail here.

That is, in the above implementation, Ctx1 may be calculated by using the planar flag information and the planar position information of the three co-planar nodes, and Ctx2 may be calculated by using the planar flag information and the planar position information of the three co-edge nodes and the planar flag information and the planar position information of the one co-vertex node. Alternatively, Ctx1 may be calculated by using the planar position information of the seven neighborhood nodes (i.e., three co-planar nodes, three co-edge nodes and one co-vertex node), and Ctx2 may be calculated by using the planar flag information of the seven neighborhood nodes (i.e., three co-planar nodes, three co-edge nodes and one co-vertex node). Here, only two calculating methods of obtaining Ctx1 and Ctx2 by using the planar structure information of the neighborhood nodes are provided, but the calculation of Ctx1 and Ctx2 is not limited by the embodiments of the present disclosure. For example, in the embodiments of the present disclosure, Ctx1 and Ctx2 may be calculated (reckoned) by using the occupancy information of the neighborhood nodes, and there is no specific limitation on how to perform the calculation.

In S1303, target context information is determined according to the context indication information.

In S1304, planar position information of the current node is determined; and the planar position information of the current node is encoded based on the target context information, and obtained encoding bits are signalled into a bitstream.

It is to be noted that in the embodiments of the present disclosure, it is necessary to determine not only the target context information, but also the planar position information of the current node, and then the planar position information of the current node is encoded by using the target context information. In some embodiments, determining the planar position information of the current node may include:
in response to the current node satisfying a condition for planar encoding, determining the planar position information of the current node to be one of: low planar position information or high planar position information.

In the embodiments of the present disclosure, regarding determining whether the current node satisfies the condition for planar coding, it may be determined according to the planar probability of the node in each dimension, or whether nodes at the current level satisfy the condition for planar coding may be determined according to the point cloud density of the current level, or whether the current node meets the condition for planar coding may be determined according to acquisition parameters of a laser radar point cloud, etc., which is not specifically limited here.

In some embodiments, the operation that the target context information is determined according to the context indication information may include:
determining the first context indication information of the current node and the second context indication information of the current node; and
determining the target context information according to the first context indication information and the second context indication information.

That is, after Ctx1 and Ctx2 are calculated by using the planar structure information of the neighborhood nodes, the target context information may be determined according to Ctx1 and Ctx2. Further, in the embodiments of the present disclosure, context mapping processing may further be performed on Ctx1 and Ctx2 to determine the target context information. Therefore, in some embodiments, determining the target context information according to the first context indication information and the second context indication information may include:
performing context mapping processing according to the first context indication information and the second context indication information, to obtain new context information; and
   determining the target context information according to the new context information.

It is also to be noted that in the embodiments of the present disclosure, Ctx1 and Ctx2 may be directly calculated by performing simple AND or OR operation using the planar structure information of multiple neighborhood nodes such as co-planar, co-edge and co-vertex nodes, and finally the target context information is determined. In addition, in the embodiments of the present disclosure, the target context information ultimately used for encoding is not limited. For example, the new context information may be obtained by performing mapping on Ctx1 and Ctx2 using methods such as spatial rotation without deformation, or context mapping, so that the target context information is determined, which is not specifically limited here.

In some embodiments, the operation that the target context information is determined according to the context indication information may include:
determining reference context information of the current node; and
determining the target context information according to the first context indication information, the second context indication information and the reference context information.

It is to be noted that in the embodiments of the present disclosure, the target context information may be determined according to Ctx1, Ctx2 and the reference context information, or mapping may be performed on Ctx1 and Ctx2 to obtain the new context information. Then, the target context information is determined according to the new context information and the reference context information, and the target context information ultimately used is not limited here.

It is also to be noted that in the embodiments of the present disclosure, the target context information may be a target context index value, then, a corresponding context model is determined based on the target context index value, and finally, the planar position information of the current node is encoded by using the context model. Alternatively, the target context information may also be a context model finally determined, and then, the planar position information of the current node is encoded by using the context model.

Further, for the existing reference context information, in some embodiments, determining the reference context information of the current node includes at least one of:
1) performing prediction according to occupancy information of the neighborhood nodes to determine a prediction value of the planar position information of the current node, where the prediction value includes one of: low plane, high plane, or unpredictable;
2) determining a spatial distance between a node at a same partitioning depth and a same coordinate as the current node and the current node, where the spatial distance satisfies one of: near distance or far distance;
3) determining whether a node at a same partitioning depth and a same coordinate as the current node is a plane, and in response to the node being a plane, determining a planar position of the node; or
4) determining coordinate dimension information of the current node.

It is to be noted that, for the current node, the neighborhood node may be searched at the same octree partitioning depth level and the same vertical coordinate, that is, a node at the same partitioning depth and the same coordinate as the current node; then determination of whether the distance between the current node and the node is “near distance” or “far distance” is performed; and when the node is a plane, the planar position of the node is referenced.

As such, the target context information ultimately used for the planar position information may be as follows:
(a) the planar position information of the current node being obtained as three elements through predicting by using the occupancy information of the neighborhood node: predicted to be low plane, predicted to be high plane, or unpredictable;
(b) the spatial distance between the node at the same partitioning depth and the same coordinate as the current node and the current node: “near distance” or “far distance”;
(c) in response to the node at the same partitioning depth and the same coordinate as the current node being a plane, the planar position of the node being determined;
(d) the coordinate dimension of the current node (i=0, 1, 2);
(e) Ctx1, for example, which is calculated by using the planar structure information of three co-planar nodes; or
(f) Ctx2, for example, which is calculated by using the planar structure information of three co-edge nodes and the planar structure information of one co-vertex node.

That is, in the embodiments of the present disclosure, the planar structure information of the neighborhood nodes is determined by using the occupancy information of the neighborhood nodes as illustrated in FIG. 11; then the context Ctx1 and Ctx2 of the planar position information of the current node is calculated by using the planar structure information of the neighborhood nodes, and finally encoding processing is performed on the planar position information of the current node by using Ctx1, Ctx2 and the existing reference context information.

In some embodiments, the embodiments of the present disclosure further provide a bitstream. The bitstream is generated by bit encoding according to information to be encoded. The information to be encoded includes at least: planar position information of the current node.

In this way, after the encoding side signals the planar position information of the current node into the bitstream through the target context information, at the decoding side subsequently, the target context information is first determined, and then decoding is performed on the planar position information of the current node by using the target context information. In addition, it is also to be noted that when the target context information is the target context index value, to speed up the decoding speed, the encoding side may also signal the target context index value into the bitstream, and thus, the decoding side may decode directly to obtain the target context index value. The context model is determined according to the target context index value, and then the planar position information of the current node is decoded by using the context model, thereby improving the decoding efficiency.

The present embodiment provides a encoding method, in which the planar structure information of the neighborhood nodes of the current node is determined; the context indication information of the current node is determined according to the planar structure information of the neighborhood nodes; the target context information is determined according to the context indication information; the planar position information of the current node is determined, and the planar position information of the current node is encoded based on the target context information, and the obtained encoded bits are signalled into a bitstream. In this way, during the process of encoding the planar position information of the current node by using the target context information, the target context information may be determined through considering the planar structure information of the neighborhood nodes of the current node; moreover, through considering the correlation between the planar structure information of the neighborhood nodes, the geometry information coding efficiency of the point cloud is effectively improved, thereby improving the encoding performance of the point cloud.

In another embodiment of the present disclosure, based on the decoding/encoding methods in the above embodiments, if the planar coding mode is adopted for the current node, predictive encoding and decoding may be performed on the planar position information of the current node by using the target context information. Thus, for the current node, it is first necessary to determine whether the current node satisfies the condition for planar coding.

In the G-PCC standards, it is determined whether a node satisfies the condition for planar coding; and when the node satisfies the condition for planar coding, it is necessary to perform predictive coding on the planar flag and planar position information.

In the embodiments of the present disclosure, there are three types of determination condition for determining whether the node satisfies planar coding, which are described in detail below.

I. The determination is performed according to the plane probability of the node in each dimension:
(1) local node density (local_node_density) of the current node is determined; and
(2) probability of the current node Prob(i) in each dimension is determined.

When the local_node_density of the node is less than a threshold Th (e.g., Th=3), the plane probabilities of the current node in three coordinate dimensions Prob(i) are compared with thresholds Th0, Th1 and Th2, where Th0<Th1<Th2 (e.g., Th0=0.6, Th1=0.77 and Th2=0.88). Here, Eligibleᵢ (i=0, 1, 2) is used to represent whether the planar coding is enabled in each dimension, Eligibleᵢ=Prob(i)>=threshold.

It is to be noted that the thresholds are adaptively changed. For example, when Prob(0)>Prob(1)>Prob(2), the setting of Eligible; is as follows:

$${Eligible}_{0} = P r o b ( 0 ) > = Th 0 ;$$

$${Eligible}_{1} = Prob ( 1 ) > = Th 1 ; and$$

$${Eligible}_{2} = Prob ( 2 ) > = Th 2.$$

When Prob(1)>Prob(0)>Prob(2), the setting of Eligible; is as follows:

$${Eligible}_{0} = P r o b ( 0 ) > = Th 0 ;$$

$${Eligible}_{1} = Prob ( 1 ) > = Th 1 ; and$$

$${Eligible}_{2} = Prob ( 2 ) > = Th 2.$$

Here, Prob(i) is updated as follows:

$$Prob {( i )}_{new} = ( L \times P r o b ( i ) + δ ( coded node ) ) / L + 1 \qquad ( 7 )$$

Where, L=255. In addition, if the coded node is a plane, δ(coded node) is 1; otherwise, δ(coded node) is 0.

Here, local_node_density is updated as follows:

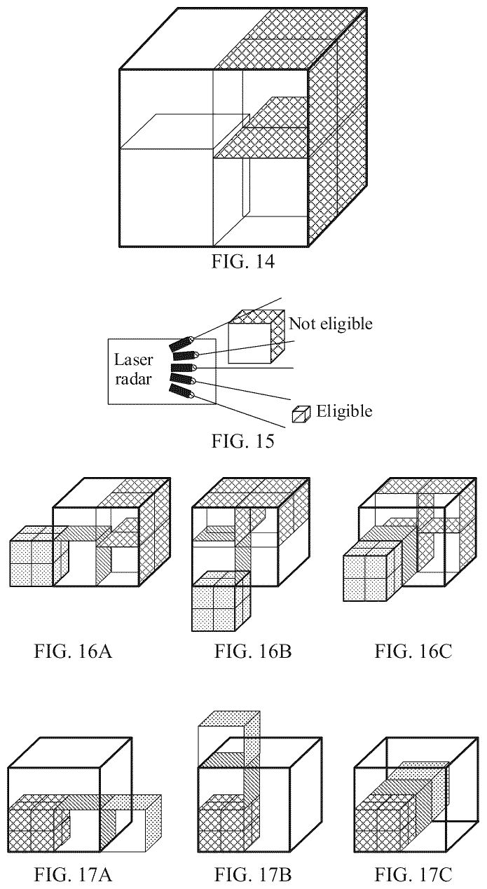

local_node_density_{new}=local_node_density+4*num Siblings (8)

Where local_node_density is initialized to 4, and numSiblings is the number of sibling nodes of such node. For example, FIG. 14 is a schematic diagram of sibling nodes of a current node provided in the embodiments of the present disclosure. As illustrated in FIG. 14, the current node is a node filled with diagonal lines and the nodes filled with grids are sibling nodes, so the number of sibling nodes of the current node is 5 (including the current node itself).

II. It is determined whether the nodes in the current level (or, layer) meet planar coding according to the point cloud density of the current level.

The density of points in the current level is used to determine whether to perform planar coding on the nodes in the current level. Assuming that the number of points in the current to-be-encoded point cloud is pointCount, and the number of points reconstructed after IDCM encoding is numPointCountRecon. Because octree coding is performed based on the order of breadth-first traversal, the number of nodes to be encoded in the current level is assumed to be nodeCount; and then the determination of whether planar coding is enabled on the current level is assumed to be planarEligibleKOctreeDepth. Specifically, planarEligibleKOctreeDepth=(pointCount-numPointCountRecon)<nodeCount×1.3.

If (pointCount-numPointCountRecon) is less than nodeCount×1.3, planarEligibleK OctreeDepth is true; if (pointCount-numPointCountRecon) is not less than nodeCount×1.3, planarEligibleKOctreeDepth is false. In this way, when planarEligibleKOctreeDepth is true, plane coding are performed on all nodes in the current layer; otherwise, plane coding are not performed on all nodes in the current layer, and only octree coding is used.

III. It is determined whether the current node meets planar coding according to the acquisition parameters of the laser radar point cloud.

FIG. 15 is an intersection schematic diagram of a laser radar with a node provided in the embodiments of the present disclosure. As illustrated in FIG. 15, the node filled with grids is passed through by two lasers simultaneously, so the current node is not a plane in the Z axis vertical direction. The node filled with diagonal lines is sufficiently small such that the node cannot be passed through by two lasers simultaneously, so the node filled with diagonal lines may be a plane in the Z axis vertical direction.

Furthermore, for a node satisfying the condition for planar coding, predictive coding may be performed on the planar mode information and the planar position information.

First, predictive coding is performed on the planar mode information.

Here, only three pieces of context information are adopted for coding, that is, context design for the planar mode in each coordinate dimension is performed separately.

Secondly, predictive coding is performed on the planar position information.

It is to be understood that, for coding of the point cloud planar position information of the non-laser radar, in the related art, the existing reference context information may include:
(a) the planar position information of the current node obtained by predicting the occupancy information of neighboring nodes, the planar position information being three elements: predicted as low plane, predicted as high plane and unpredictable;
(b) the spatial distance between a node at the same partitioning depth and coordinates as the current node and the current node: “near” and “far”;
(c) if the node at the same partitioning depth and the same coordinates as the current node is a plane, the planar position of the node being determined; and
(d) coordinate dimension of the current node (i=0, 1, 2).

Specifically, taking the above FIG. 12 as an example, the current node is a small cube filled with grids; then, the neighbor node (small cube filled with white) is searched at the same octree partitioning depth level and the same vertical coordinate, the distance between the two nodes is determined as “near” or “far”, and the planar position of the node is referenced.

In the embodiments of the present disclosure, FIG. 16A to FIG. 16C are schematic diagrams of a current node located at a low planar position of a parent node provided by the embodiments of the present disclosure. As illustrated in FIG. 16A to FIG. 16C, three examples in which the current node is located at the low planar position of the parent node are illustrated. The specific instructions are as follows.
I: If any one of child nodes 4 to 7 of a node filled with points is occupied, and all nodes filled with grids are not occupied, there is a high probability that there is a plane in the current node (filled with diagonal lines), and the planar position is located lower.
II: If none of the child nodes 4 to 7 of the node filled with points is occupied, and any node filled with grids are occupied, there is a high probability that there is a plane in the current node (filled with diagonal lines), and the planar position is located higher.
III: If all the child nodes 4 to 7 of the node filled with points are empty nodes, and all the nodes filled with grids are empty nodes, the planar position cannot be inferred and is therefore marked as unknown.

IV: If any one of the child nodes 4 to 7 of the node filled with points is occupied, and any one of the nodes filled with grids is occupied, the planar position still cannot be inferred and is therefore marked as unknown.

In the embodiments of the present disclosure, FIG. 17A to FIG. 17C are schematic diagrams of a current node located at a high planar position of a parent node provided by the embodiments of the present disclosure. As illustrated in FIG. 17A to FIG. 17C, three examples in which the current node is located at the high plane position of the parent node are illustrated. The specific instructions are as follows.
I: If any one of child nodes 4 to 7 of a node filled with grids is occupied, and a node filled with points is not occupied, there is a high probability that there is a plane in the current node (filled with diagonal lines), and the planar position is located lower.
II: If the child nodes 4 to 7 of the node filled with grids are not occupied, and the node filled with points is occupied, there is a high probability that there is a plane in the current node (filled with diagonal lines), and the planar position is located higher.
III: If all the child nodes 4 to 7 of the node filled with grids are not occupied, and the node filled with points is not occupied, the planar position cannot be inferred and is therefore marked as unknown.
IV: If one of the child nodes 4 to 7 of the node filled with grids is occupied, and the node filled with points is occupied, the planar position cannot be inferred and is therefore marked as unknown.

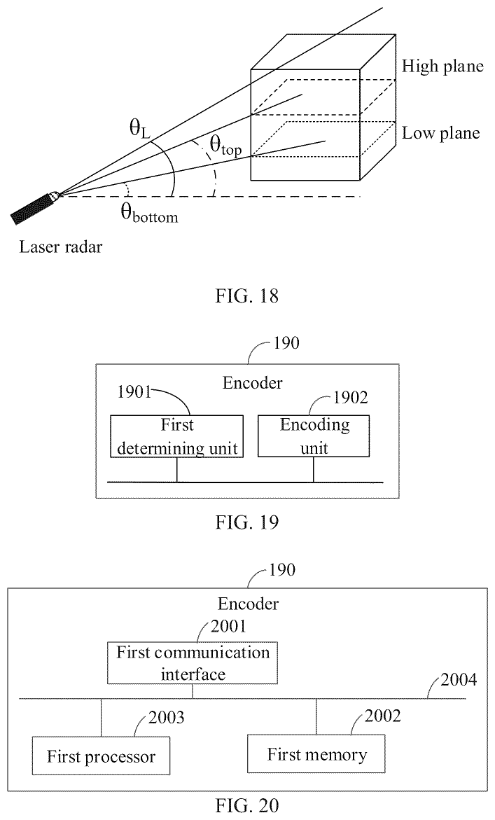

It is also to be understood that for coding of the point cloud planar position information of the laser radar, FIG. 18 is a schematic diagram of predictive encoding of planar position information of a laser radar point cloud provided by the embodiments of the present disclosure. As illustrated in FIG. 18, when the emission angle of the laser radar is bottom, the node may be mapped as a bottom virtual plane; and when the emission angle of the laser radar is top, the node may be mapped as a top virtual plane.

That is, the planar position of the current node is predicted by using the laser radar acquisition parameters, and the position is quantified into multiple intervals by using the position where the current node intersects with the laser ray, and finally, to serve as the context information of the planar position of the current node. The specific calculation process is as follows: assuming that the coordinates of the laser radar are (x_{Lidar}, y_{Lidar}, z_{Lidar}), and the geometric coordinates of the current node are (x, y, z), then a vertical tangent value tan 0 of the current node relative to the laser radar is calculated firstly. The calculation formula is as follows:

$$tan θ = \frac{z - {z}_{Lidar}}{\sqrt{{( x - {x}_{Lidar} )}^{2} + {( y - {y}_{Lidar} )}^{2}}} \qquad ( 9 )$$

Further, since each Laser has a certain offset angle relative to the laser radar, it is further necessary to calculate a relative tangent value tan θ_{corr, L} of the current node relative to the Laser. The specific calculation is as follows:

$$tan {θ}_{corr , L} = \frac{z - {z}_{Lidar} - {z}_{L}}{\sqrt{{( x - {x}_{Lidar} )}^{2} + {( y - {y}_{Lidar} )}^{2}}} = tan θ - \frac{{z}_{L}}{r} \qquad ( 10 )$$

Finally, prediction is performed on the planar position of the current node by using the relative tangent value tan θ_{corr, L} of the current node. Specifically, assuming that a tangent value of a lower boundary of the current node is tan(θ_{bottom}), and a tangent value of a top boundary is tan (θₜₒₚ), the planar position is quantized into 4 quantization intervals according to tan θ_{corr, L}, that is, the context information of the planar position is determined.

In this way, when it is determined that the current node satisfies the condition for planar coding, predictive encoding and decoding are performed on the planar position information of the current node not only by partial prior reference information in the related art, but also by considering the planar structure information of the neighborhood nodes, so as to improve the planar coding efficiency of the current node.

In the embodiments of the present disclosure, the technical solution may be implemented at both the encoding side and the decoding side. When the current node satisfies the condition for planar coding, predictive encoding is performed on the planar position information of the current node by using the occupancy information of the neighborhood nodes. The octree encoding side algorithm, specifically as illustrated in FIG. 11, when the occupancy information of the current node is encoded and decoded according to the order of point cloud encoding and decoding, the occupancy information of the seven neighborhood nodes that are sharing a face, an edge and a vertex with the current node (at left/front/below direction) may be obtained. Predictive encoding is performed on the planar position information of the current node by using the occupancy information of these neighborhood nodes.

For example, taking the predictive encoding of the planar position information in the X-axis direction as an example, assuming that the contexts of the planar position information used for the current node are Ctx1 and Ctx2, the corresponding calculation methods are as follows.

Ctx1: Ctx1 is designed using the planar structure information of three co-planar neighborhood nodes. Assuming that the occupancy information of the three co-planar neighborhood nodes is coPlanarLeft, coPlanarFront and coPlanarBelow, the planar structure information (Including planar flag (planarMode) and planar position (PlanePos) information) of the three (co-planar) nodes is first calculated by using the occupancy information of the three co-planar neighborhood nodes. Here, the respective planar structure information of each co-planar neighborhood node is calculated by using the occupancy information of the three co-planar neighborhood nodes, in which the planar structure information is coPlanarLeftPlaneMode, coPlanarLeftPlanePos, coPlanarFrontPlaneMode, coPlanarFrontPlanePos, coPlanarBelowPlaneMode and coPlanarBelowPlanePos, respectively. Then, Ctx1 is calculated by using the planar structure information of the three co-planar neighborhood nodes, see formula (3) for details.

Ctx2: Ctx2 is designed using the occupancy information of three co-edge neighborhood nodes and one co-vertex neighborhood node, which is assumed to be: coEdgerLeft, coEdgerFront, coEdgerBelow and coVertex. The respective planar structure information corresponding to each neighborhood node is first calculated by using the occupancy information of these neighborhood nodes, in which the planar structure information is: coEdgerLeftPlaneMode, coEdgerLeftPlanePos, coEdgerFrontPlaneMode, coEdgerFrontPlanePos, coEdgerBelowPlaneMode, coEdgerBelowPlanePos, co VertexPlaneMode and coVertexPlanePos. Then, Ctx2 is calculated by using the planar structure information corresponding to these neighborhood nodes, see formula (4) for details.

As such, finally, the target context information of the planar position is as follows:
(a) the planar position information of the current node being obtained as three elements through predicting by using the occupancy information of the neighborhood node: predicted to be low plane, predicted to be high plane, or unpredictable;
(b) the spatial distance between the node at the same partitioning depth and the same coordinate as the current node and the current node: “near distance” or “far distance”;
(c) in response to the node at the same partitioning depth and the same coordinate as the current node being a plane, the planar position of the node being determined;
(d) the coordinate dimension of the current node (i=0, 1, 2);
(e) Ctx1, which is calculated by using the planar structure information of three co-planar nodes;
(f) Ctx2, which is calculated by using the planar structure information of three co-edge nodes and one co-vertex node.

For the octree decoding side algorithm, similar to the encoding side algorithm, the contexts Ctx1 and Ctx2 of the planar position information of the current node are obtained by using the occupancy information of the neighborhood nodes as illustrated in FIG. 11, and finally, decoding is performed on the planar position information of the current node by using Ctx1, Ctx2 and the existing reference context information.

Further, in the embodiments of the present disclosure, Ctx1 is calculated by using the planar position information and the planar flag information of the three co-planar neighborhood nodes, and Ctx2 is calculated by using the planar position information and the planar flag information of the three co-edge neighborhood nodes and one co-vertex neighborhood node. In addition, the calculation of Ctx1 includes only the planar position information of the seven neighborhood nodes, and the calculation of Ctx2 includes only the planar flag information of the seven neighborhood nodes, see equations (5) and (6) for details.

Further, in the embodiments of the present disclosure, the calculation of Ctx1 and Ctx2 is not limited thereto. Here, only two calculating methods of obtaining Ctx1 and Ctx2 by using the planar structure information of the neighborhood nodes are provided, but the calculation of Ctx1 and Ctx2 is not limited thereto. What is protected in the embodiments of the present disclosure is that Ctx1 and Ctx2 are calculated (or reckoned) by using the occupancy information of the neighborhood nodes, but there is no limitation on how to perform the calculation.

Further, in the embodiments of the present disclosure, there may be no limitation on the reference range of the neighborhood nodes. Considering the balance between encoding efficiency, time complexity, memory occupancy rate or the like, only the occupancy information of seven neighborhood nodes (i.e., three co-planar nodes, three co-edge nodes and one co-vertex node) is considered here, but there is no limitation on the neighborhood reference range. For example, only co-planar neighborhood nodes may be referenced, or co-planar neighborhood nodes and co-edge neighborhood nodes may be referenced, or a larger neighborhood reference range may be referenced, which is not specifically limited here.

Further, in the embodiments of the present disclosure, the reference information finally obtained by using the occupancy information of the neighborhood nodes and the context used for the planar position are not limited thereto. Ctx1 and Ctx2 may be directly calculated by performing simple AND or OR operation using the planar structure information of neighborhood nodes such as co-planar, co-edge and co-vertex nodes, and finally Ctx1 and Ctx2 are used for determining the context of planar position encoding. In the embodiments of the present disclosure, the context ultimately used for encoding is not limited. For example, the new context information may be obtained by performing mapping on Ctx1 and Ctx2 using methods such as spatial rotation without deformation, or context mapping, which is not specifically limited here.

In this way, according to the technical solutions of the embodiments of the present disclosure, predictive encoding may be performed on the planar position information of the current node by considering the planar structure information of the neighborhood nodes, which can improve the geometric coding efficiency of the point cloud. Taking the geometric lossless attribute lossless test environment as an example below, where Bits Per Point (Bpp) is the performance indicator for measuring compression efficiency, when bpp is less than 100%, it means that the coding efficiency is improved compared with the existing coding solutions, as illustrated in Table 1.

TABLE 1

| Test Sequences | Test results (Geometry_bpp) |
|---|---|
| egyptian_mask_vox12 | 97.124% |
| facade_00009_vox12 | 96.340% |
| facade_00015_vox14 | 96.740% |
| frog_00067_vox12 | 95.015% |
| house_without_roof_00057_vox12 | 96.777% |
| shiva_00035_vox12 | 97.763% |
| ulb_unicorn_vox13 | 99.722% |
| arco_valentino_dense_vox12 | 99.866% |
| arco_valentino_dense_vox20 | 99.941% |
| egyptian_mask_vox20 | 99.071% |
| facade_00009_vox20 | 99.154% |
| facade_00015_vox20 | 98.989% |
| facade_00064_vox14 | 96.055% |
| facade_00064_vox20 | 99.070% |
| frog_00067_vox20 | 98.862% |
| head_00039_vox20 | 99.230% |
| house_without_roof_00057_vox20 | 98.800% |
| landscape_00014_vox20 | 98.710% |
| palazzo_carignano_dense_vox14 | 99.879% |
| palazzo_carignano_dense_vox20 | 99.947% |
| shiva_00035_vox20 | 99.345% |
| stanford_area_2_vox16 | 99.590% |
| stanford_area_2_vox20 | 99.610% |
| staue_klimt_vox12 | 95.984% |
| staue_klimt_vox20 | 98.876% |
| ulb_unicorn_hires_vox15 | 98.008% |
| ulb_unicorn_hires_vox20 | 99.327% |
| ulb_unicorn_vox20 | 99.907% |
| citytunnel_q1mm | 99.066% |
| overpass_q1mm | 98.886% |
| tollbooth_q1mm | 98.665% |

After experimental testing, it can be seen from Table 1 that, on the selected test sequence set, a single test sequence can improve the compression performance by up to 5% (frog_00067_vox12). Exemplarily, Table 2 shows the performance results under lossless geometry and lossless attributes, and Table 3 shows the performance results under lossy geometry and lossy attributes.

TABLE 2

| | Lossless geometry, Lossless attributes[all intra] | | | |
|---|---|---|---|---|
| | bpip ratio[%] | | | |
| CW_ai | Geometry | Color | Reflectance | Total |
| Cat1-A average | 97.9% | 100.0% | | 99.3% |
| Cat1-B average | 99.2% | 100.0% | | 99.5% |
| Cat3-fused average | 98.9% | 100.0% | 100.0% | 99.4% |
| Cat3-frame average | 100.0% | | 100.0% | 100.0% |
| Overall average | 99.1% | 100.0% | 100.0% | 99.5% |

| | |
|---|---|
| Avg.Enc.Time[%] | #NUM! |
| Avg.Dec.Time[%] | #NUM! |

TABLE 3

| | Lossy geometry, Lossy attributes[all intra] | | | | | |
|---|---|---|---|---|---|---|
| | End-to-End BD-AttrRate[%] | | | | | |
| | | Chroma | Chroma | | Geom_BD-TotGeomRate[%] | |
| C2_ai | Luma | Cb | Cr | Reflectance | D1 | D2 |
| Cat1-A average | 0.0% | 0.0% | 0.0% | | −0.2% | −0.2% |
| Cat1-B average | 0.0% | 0.0% | 0.0% | | −1.0% | −1.0% |
| Cat3-fused | 0.0% | 0.0% | 0.0% | 0.0% | −1.3% | −1.3% |
| average | | | | | | |
| Cat3-frame | | | | 0.0% | 0.0% | 0.0% |
| average | | | | | | |
| Overall average | 0.0% | 0.0% | 0.0% | 0.0% | −0.5% | −0.5% |

| | |
|---|---|
| Avg.Enc.Time[%] | #NUM! |
| Avg.Dec.Time[%] | #NUM! |

In addition, with the planar coding of all test sequences turned on, the test performance of the existing TMC13-v19 is shown in Table 4.

TABLE 4

| | Lossless geometry, Lossless attributes[all intra] | | | |
|---|---|---|---|---|
| | bpip ratio[%] | | | |
| CW_ai | Geometry | Color | Reflectance | Total |
| Cat1-A average | 95.0% | 100.0% | | 98.5% |
| Cat1-B average | 99.2% | 100.0% | | 99.5% |
| Cat3-fused average | 98.9% | 100.0% | 100.0% | 99.4% |
| Cat3-frame average | 100.0% | | 100.0% | 100.0% |
| Overall average | 98.8% | 100.0% | 100.0% | 99.3% |

| | |
|---|---|
| Avg.Enc.Time[%] | #NUM! |
| Avg.Dec.Time[%] | #NUM! |

In the embodiments of the present disclosure, the specific implementations of the above embodiments are described in detail through the above embodiments, from which it may be seen that when the planar position information of the node is encoded or decoded according to the technical solutions of the above embodiments, predictive encoding and decoding are performed on the planar position information of the current node by considering the planar structure information of the neighborhood nodes, so that the geometry information coding efficiency of the point cloud is effectively improved by considering the correlation between the planar structure information of the neighboring nodes. In addition, in the embodiments of the present disclosure, prediction is performed on the planar position information of the current node by using the planar structure information of the seven co-planar, co-edge and co-vertex neighborhood nodes of the current node, and similarly, more abundant planar structure information of the neighborhood nodes may be considered, which is not limited here, so that the geometry information coding efficiency of the point cloud is further improved, thereby improving the encoding and decoding performance of the point cloud.

In yet another embodiment of the present disclosure, based on the same inventive concept as the above embodiments, referring to FIG. 19, a schematic structure diagram of compositions of an encoder provided by the embodiments of the present disclosure is illustrated. As illustrated in FIG. 19, an encoder 190 may include: a first determining unit 1901 and an encoding unit 1902.

The first determining unit 1901 is configured to determine planar structure information of neighborhood nodes of a current node; determine context indication information of the current node according to the planar structure information of the neighborhood nodes; determine target context information according to the context indication information; and determine planar position information of the current node.

The encoding unit 1902 is configured to encode the planar position information of the current node based on the target context information, and signal obtained encoded bits into a bitstream.

In some embodiments, the first determining unit 1901 is further configured to determine, in response to the current node satisfying a condition for planar coding, the planar position information of the current node to be one of: low planar position information or high planar position information.

In some embodiments, the neighborhood nodes include at least one of: at least one co-planar node sharing a face with the current node, at least one co-edge node sharing an edge with the current node, or at least one co-vertex node sharing a vertex with the current node.

In some embodiments, the first determination unit 1901 is further configured to determine planar structure information of first-type neighborhood nodes and planar structure information of second-type neighborhood nodes according to the planar structure information of the neighborhood nodes; determine first context indication information of the current node according to the planar structure information of the first-type neighborhood nodes; and determine second context indication information of the current node according to the planar structure information of the second-type neighborhood nodes.

In some embodiments, in response to the first-type neighborhood nodes including three co-planar nodes sharing a face with the current node, the first determination unit 1901 is further configured to determine occupancy information of the three co-planar nodes; determine planar flag information of the three co-planar nodes and planar position information of the three co-planar nodes according to the occupancy information of the three co-planar nodes; compose the planar structure information of the first-type neighborhood nodes according to the planar flag information of the three co-planar nodes and the planar position information of the three co-planar nodes; and determine the first context indication information of the current node according to the planar flag information of the three co-planar nodes and the planar position information of the three co-planar nodes.

In some embodiments, in response to the second-type neighborhood nodes including three co-edge nodes sharing an edge with the current node and one co-vertex node sharing a vertex with the current node, the first determination unit 1901 is further configured to determine occupancy information of the three co-edge nodes and occupancy information of the one co-vertex node; determine planar flag information of the three co-edge nodes and planar position information of the three co-edge nodes according to the occupancy information of the three co-edge nodes, and determine planar flag information of the one co-vertex node and planar position information of the one co-vertex node according to the occupancy information of the one co-vertex node; compose the planar structure information of the second-type neighborhood nodes according to the planar flag information of the three co-edge nodes, the planar flag information of the one co-vertex node, the planar position information of the three co-edge nodes and the planar position information of the one co-vertex node; and determine the second context indication information of the current node according to the planar flag information of the three co-edge nodes, the planar flag information of the one co-vertex node, the planar position information of the three co-edge nodes and the planar position information of the one co-vertex node.

In some embodiments, the first determination unit 1901 is further configured to determine first-type planar structure information of the neighborhood nodes and second-type planar structure information of the neighborhood nodes according to the planar structure information of the neighborhood nodes; determine first context indication information of the current node according to the first-type planar structure information of the neighborhood nodes; and determine second context indication information of the current node according to the second-type planar structure information of the neighborhood nodes.

In some embodiments, in response to the neighborhood nodes including three co-planar nodes sharing a face with the current node, three co-edge nodes sharing an edge with the current node and one co-vertex node sharing a vertex with the current node, the first determination unit 1901 is further configured to determine respective occupancy information of the three co-planar nodes, the three co-edge nodes and the one co-vertex node; determine, according to the respective occupancy information of the three co-planar nodes, the three co-edge nodes and the one co-vertex node, planar position information of the three co-planar nodes, planar position information of the three co-edge nodes and planar position information of the one co-vertex nodes; compose the first-type planar structure information of the neighborhood nodes according to the planar position information of the three co-planar nodes, the planar position information of the three co-edge nodes and the planar position information of the one co-vertex node; and determine the first context indication information of the current node according to the planar position information of the three co-planar nodes, the planar position information of the three co-edge nodes and the planar position information of the one co-vertex node.

In some embodiments, in response to the neighborhood nodes including three co-planar nodes sharing a face with the current node, three co-edge nodes sharing an edge with the current node and one co-vertex node sharing a vertex with the current node, the first determination unit 1901 is further configured to determine respective occupancy information of the three co-planar nodes, the three co-edge nodes and the one co-vertex node; determine, according to the respective occupancy information of the three co-planar nodes, the three co-edge nodes and the one co-vertex node, planar flag information of the three co-planar nodes, planar flag information of the three co-edge nodes and planar flag information of the one co-vertex node; compose the second-type planar structure information of the neighborhood nodes according to the planar flag information of the three co-planar nodes, the planar flag information of the three co-edge nodes and the planar flag information of the one co-vertex node; and determine the second context indication information of the current node according to the planar flag information of the three co-planar nodes, the planar flag information of the three co-edge nodes and the planar flag information of the one co-vertex node.

In some embodiments, the first determining unit 1901 is further configured to determine the first context indication information of the current node and the second context indication information of the current node; and determine the target context information according to the first context indication information and the second context indication information.

In some embodiments, the first determining unit 1901 is further configured to perform context mapping processing according to the first context indication information and the second context indication information, to obtain new context information; and determine the target context information according to the new context information.

In some embodiments, the first determining unit 1901 is further configured to determine reference context information of the current node; and determine the target context information according to the first context indication information, the second context indication information and the reference context information.

In some embodiments, the first determining unit 1901 is further configured to determine the reference context information of the current node, which including at least one of:
1) performing prediction according to occupancy information of the neighborhood nodes to determine a prediction value of the planar position information of the current node, where the prediction value includes one of: low planar, high planar, or unpredictable;
2) determining a spatial distance between a node at a same partition depth and a same coordinate as the current node and the current node, where the spatial distance satisfies one of: near distance or far distance;
3) determining whether a node at a same partition depth and a same coordinate as the current node is a plane, and if the node is a plane, determining a planar position of the node; or
4) determining coordinate dimension information of the current node.

It is to be understood that in the embodiments of the present disclosure, the “unit” may be part of a circuit, part of a processor, part of a program or software, or the like, and may also be a module or may be non-modular. Moreover, various components in the embodiment may be integrated into one processing unit, or each unit may be physically present alone, or two or more units may be integrated into one unit. The above integrated units may be implemented in the form of hardware or software function modules.

The integrated units may be stored in a computer readable storage when it is implemented in the form of software functional modules and is not sold or used as a separate product. Based on such understanding, the technical solutions of the embodiments essentially, or the part of the technical solutions that contribute to the related art, or all or part of the technical solutions, may be embodied in the form of a computer software product which is stored in a storage medium and includes various instructions for causing a computer device (which may be a personal computer, a server, or a network device and so on) or a processor to perform all or part of the steps of the method described in the various embodiments of the present disclosure. The above storage medium includes various media that can store program codes, such as a USB flash drive (U disk), a mobile hard disk, a read only memory (ROM), a random access memory (RAM), a diskette, or an optical disk.

Therefore, the embodiments of the present disclosure provide a non-transitory computer-readable storage medium, which is applied to an encoder 190. The non-transitory computer-readable storage medium has a computer program stored thereon, and the computer program, when executed by the first processor, implements the encoding methods described in any one of the above embodiments.

Based on the compositions of the encoder 190 and the non-transitory computer-readable storage medium, referring to FIG. 20, a specific hardware structure diagram of the encoder 190 provided by the embodiments of the present disclosure is illustrated. As illustrated in FIG. 20, the encoder 190 may include: a first communication interface 2001, a first memory 2002 and a first processor 2003. Each component is coupled together via a first bus system 2004. It is to be understood that the first bus system 2004 is configured to achieve connection and communication between these components. In addition to a data bus, the first bus system 2004 further includes a power bus, a control bus and a status signal bus. However, for the sake of clarity, various buses are labeled as the first bus system 2004 in FIG. 20.

The first communication interface 2001 is configured to receive and transmit signals in the process of transmitting and receiving information with other external network elements.

The first memory 2002 is configured to store a computer program executable on the first processor 2003.

The first processor 2003 is configured to, when executing the computer program, perform:
determining planar structure information of neighborhood nodes of a current node;
determining context indication information of the current node according to the planar structure information of the neighborhood nodes;
determining target context information according to the context indication information;
determining planar position information of the current node; and
encoding the planar position information of the current node based on the target context information, and signalling obtained encoded bits into a bitstream.

It is to be understood that the first memory 2002 in the embodiments of the present disclosure may be a volatile memory or a non-volatile memory, or may include both volatile and non-volatile memories. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), which acts as an external cache memory. By way of example but not limitation, many forms of RAM are available, such as a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchronous link dynamic random access memory (Synchlink DRAM, SLDRAM), and a direct memory bus random access memory (Direct Rambus RAM, DRRAM). The first memory 2002 of the systems and methods described herein is intended to include, but is not limited to, these and any other suitable types of memory.

The first processor 2003 may be an integrated circuit chip having a signal processing capability. In the implementation process, various steps of the above methods may be completed by an integrated logic circuit of hardware or an instruction in the form of software in the first processor 2003. The first processor 2003 mentioned above may be a general-purpose processor, a digital signal processor (DSP), an application-specific integrated circuit (ASIC), a field programmable gate array (FPGA) or other programmable logic devices, discrete gate or transistor logic devices, and discrete hardware components. Various methods, steps and logic diagrams disclosed in the embodiments of the present disclosure may be implemented or performed. A general purpose processor may be a microprocessor, or the processor may be any conventional processor or the like. The steps of the method disclosed according to the embodiments of the present disclosure may be directly implemented by a hardware decoding processor, or may be implemented by a combination of hardware and software modules in the decoding processor. The software module may be located in a random access memory, a flash memory, a read-only memory, a programmable read-only memory, or an electrically erasable programmable memory, a register, or other mature storage media in the art. The storage medium is located in the first memory 2002, and the first processor 2003 reads the information in the first memory 2002 and completes the steps of the above methods in combination with its hardware.

It is to be understood that the embodiments described in the present disclosure may be implemented by hardware, software, firmware, middleware, microcode, or a combination thereof. For hardware implementation, the processing unit may be implemented in one or more application specific integrated circuits (ASIC), digital signal processing (DSP), digital signal processing devices (DSPD), programmable logic devices (PLD), field programmable gate arrays (FPGA), general-purpose processors, controllers, microcontrollers, microprocessors, other electronic units configured to perform the functions described in the present disclosure, or a combination thereof. For software implementation, the technology described in the present disclosure may be implemented through modules (e.g., procedures, functions) that perform the functions described in the present disclosure. The software codes may be stored in a memory and executed by a processor. The memory may be implemented within the processor or external to the processor.

Optionally, as another embodiment, the first processor 2003 is further configured to perform the encoding methods described in any one of the above embodiments when executing the computer program.

The present embodiment provides an encoder. For the encoder, during the process of encoding the planar position information of the current node by using the target context information, the target context information may be determined through considering the planar structure information of the neighborhood nodes of the current node; moreover, through considering the correlation between the planar structure information of the neighborhood nodes, the geometry information coding efficiency of the point cloud is effectively improved, thereby improving the encoding and decoding performance of the point cloud.

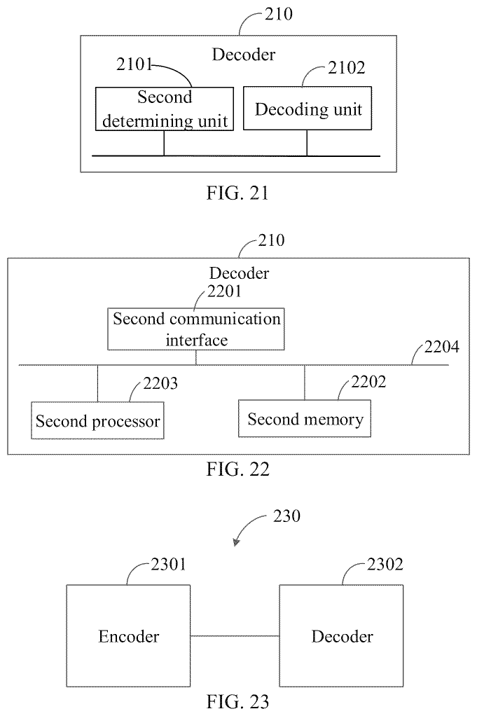

In yet another embodiment of the present disclosure, based on the same inventive concept as the above embodiments, referring to FIG. 21, a schematic structure diagram of compositions of a decoder provided by the embodiments of the present disclosure is illustrated. As illustrated in FIG. 21, a decoder 210 may include: a second determining unit 2101 and a decoding unit 2102.

The second determining unit 2101 is configured to determine planar structure information of neighborhood nodes of a current node; determine context indication information of the current node according to the planar structure information of the neighborhood nodes; and determine target context information according to the context indication information.

The decoding unit 2102 is configured to decode a bitstream based on the target context information to determine planar position information of the current node.

In some embodiments, the neighborhood nodes include at least one of: at least one co-planar node sharing a face with the current node, at least one co-edge node sharing an edge with the current node, or at least one co-vertex node sharing a vertex with the current node.

In some embodiments, the second determination unit 2101 is further configured to determine planar structure information of first-type neighborhood nodes and planar structure information of second-type neighborhood nodes according to the planar structure information of the neighborhood nodes; determine first context indication information of the current node according to the planar structure information of the first-type neighborhood nodes; and determine second context indication information of the current node according to the planar structure information of the second-type neighborhood nodes.

In some embodiments, in response to the first-type neighborhood nodes including three co-planar nodes sharing a face with the current node, the second determination unit 2101 is further configured to determine occupancy information of the three co-planar nodes; determine planar flag information of the three co-planar nodes and planar position information of the three co-planar nodes according to the occupancy information of the three co-planar nodes; compose the planar structure information of the first-type neighborhood nodes according to the planar flag information of the three co-planar nodes and the planar position information of the three co-planar nodes; and determine the first context indication information of the current node according to the planar flag information of the three co-planar nodes and the planar position information of the three co-planar nodes.

In some embodiments, in response to the second-type neighborhood nodes including three co-edge nodes sharing an edge with the current node and one co-vertex node sharing a vertex with the current node, the second determination unit 2101 is further configured to determine occupancy information of the three co-edge nodes and occupancy information of the one co-vertex node; determine planar flag information of the three co-edge nodes and planar position information of the three co-edge nodes according to the occupancy information of the three co-edge nodes, and determine planar flag information of the one co-vertex node and planar position information of the one co-vertex node according to the occupancy information of the one co-vertex node; compose the planar structure information of the second-type neighborhood nodes according to the planar flag information of the three co-edge nodes, the planar flag information of the one co-vertex node, the planar position information of the three co-edge nodes and the planar position information of the one co-vertex node; and determine the second context indication information of the current node according to the planar flag information of the three co-edge nodes, the planar flag information of the one co-vertex node, the planar position information of the three co-edge nodes and the planar position information of the one co-vertex node.

In some embodiments, the second determination unit 2101 is further configured to determine first-type planar structure information of the neighborhood nodes and second-type planar structure information of the neighborhood nodes according to the planar structure information of the neighborhood nodes; determine first context indication information of the current node according to the first-type planar structure information of the neighborhood nodes; and determine second context indication information of the current node according to the second-type planar structure information of the neighborhood nodes.

In some embodiments, in response to the neighborhood nodes including three co-planar nodes sharing a face with the current node, three co-edge nodes sharing an edge with the current node and one co-vertex node sharing a vertex with the current node, the second determination unit 2101 is further configured to determine respective occupancy information of the three co-planar nodes, the three co-edge nodes and the one co-vertex node; determine, according to the respective occupancy information of the three co-planar nodes, the three co-edge nodes and the one co-vertex node, planar position information of the three co-planar nodes, planar position information of the three co-edge nodes and planar position information of the one co-vertex node; compose the first-type planar structure information of the neighborhood nodes according to the planar position information of the three co-planar nodes, the planar position information of the three co-edge nodes and the planar position information of the one co-vertex node; and determine the first context indication information of the current node according to the planar position information of the three co-planar nodes, the planar position information of the three co-edge nodes and the planar position information of the one co-vertex node.

In some embodiments, in response to the neighborhood nodes including three co-planar nodes sharing a face with the current node, three co-edge nodes sharing an edge with the current node and one co-vertex node sharing a vertex with the current node, the second determination unit 2101 is further configured to determine respective occupancy information of the three co-planar nodes, the three co-edge nodes and the one co-vertex node; determine, according to the respective occupancy information of the three co-planar nodes, the three co-edge nodes and the one co-vertex node, planar flag information of the three co-planar nodes, planar flag information of the three co-edge nodes and planar flag information of the one co-vertex node; compose the second-type planar structure information of the neighborhood nodes according to the planar flag information of the three co-planar nodes, the planar flag information of the three co-edge nodes and the planar flag information of the one co-vertex node; and determine the second context indication information of the current node according to the planar flag information of the three co-planar nodes, the planar flag information of the three co-edge nodes and the planar flag information of the one co-vertex node.

In some embodiments, the second determining unit 2101 is further configured to determine the first context indication information of the current node and the second context indication information of the current node; and determine the target context information according to the first context indication information and the second context indication information.

In some embodiments, the second determining unit 2101 is further configured to perform context mapping processing according to the first context indication information and the second context indication information, to obtain new context information; and determine the target context information according to the new context information

In some embodiments, the second determining unit 2101 is further configured to determine reference context information of the current node; and determine the target context information according to the first context indication information, the second context indication information and the reference context information.

In some embodiments, the second determining unit 2101 is further configured to determine the reference context information of the current node, which includes at least one of:
1) performing prediction according to occupancy information of the neighborhood nodes to determine a prediction value of the planar position information of the current node, where the prediction value includes one of: low plane, high plane, or unpredictable;
2) determining a spatial distance between a node at a same partitioning depth and a same coordinate as the current node and the current node, where the spatial distance includes one of: near distance or far distance;
3) determining whether a node at a same partitioning depth and a same coordinate as the current node is a plane, and in response to the node being a plane, determining a planar position of the node; or
4) determining coordinate dimension information of the current node.

It is to be understood that in the present embodiment, the “unit” may be part of a circuit, part of a processor, part of a program or software, or the like, and may also be a module or may be non-modular. Moreover, various components in the embodiment may be integrated into one processing unit, or each unit may be physically present alone, or two or more units may be integrated into one unit. The above integrated unit may be implemented in the form of hardware or software function modules.

The integrated unit may be stored in a computer readable storage when it is implemented in the form of software functional modules and is not sold or used as a separate product. Based on such understanding, the embodiment provides a non-transitory computer-readable storage medium, which is applied to a decoder 210. The non-transitory computer-readable storage medium has a computer program stored thereon, and the computer program, when executed by the second processor, implements the decoding methods described in any one of the above embodiments.

Based on the compositions of the decoder 210 and the non-transitory computer-readable storage medium, referring to FIG. 22, a specific hardware structure diagram of the decoder 210 provided by the embodiments of the present disclosure is illustrated. As illustrated in FIG. 22, the decoder 210 may include: a second communication interface 2201, a second memory 2202 and a second processor 2203. Each component is coupled together via a second bus system 2204. It is to be understood that the second bus system 2204 is configured to achieve connection and communication between these components. In addition to a data bus, the second bus system 2204 further includes a power bus, a control bus and a status signal bus. However, for the sake of clarity, various buses are labeled as the second bus system 2204 in FIG. 22.

The second communication interface 2201 is configured to receive and transmit signals in the process of transmitting and receiving information with other external network elements.

The second memory 2202 is configured to store a computer program executable on the second processor 2203.

The second processor 2203 is configured to, when executing the computer program, perform:
determining planar structure information of neighborhood nodes of a current node;
determining context indication information of the current node according to the planar structure information of the neighborhood nodes;
determining target context information according to the context indication information;
decoding a bitstream based on the target context information to determine planar position information of the current node.

Optionally, as another embodiment, the second processor 2203 is further configured to perform the decoding methods described in any one of the above embodiments when executing the computer program.

It is to be understood that the hardware functions of the second memory 2202 are similar to these of the first memory 2002, and the hardware functions of the second processor 2203 are similar to these of the first processor 2003, which will not be described in detail here.

The embodiments of the present disclosure provide a decoder. For the decoder, during the process of decoding the planar position information of the current node by using the target context information, the target context information may be determined through considering the planar structure information of the neighborhood nodes of the current node; moreover, through considering the correlation between the planar structure information of the neighborhood nodes, the geometry information coding efficiency of the point cloud can be effectively improved, thereby improving the encoding and decoding performance of the point cloud.

In yet another embodiment of the present disclosure, referring to FIG. 23, a schematic structure diagram of compositions of an encoding and decoding system provided by the embodiments of the present disclosure is illustrated. As illustrated in FIG. 23, the encoding and decoding system 230 may include an encoder 2301 and a decoder 2302.

In the embodiments of the present disclosure, the encoder 2301 may be the encoder described in any one of the above embodiments, and the decoder 2302 may be the decoder described in any one of the above embodiments.

It is to be noted that, in the present disclosure, the terms “comprising”, “including” or any other variations thereof are intended to encompass a non-exclusive inclusion, so that a process, method, article or apparatus including a series of elements includes not only those elements, but also other elements not explicitly listed, or also includes elements inherent to such process, method, article or apparatus. Without more limitations, an element defined by the phrase “comprising a . . . ” does not exclude the presence of other identical elements in the process, method, article or apparatus comprising the element.

The serial numbers of the above embodiments of the present disclosure are for description only and do not represent the advantages or disadvantages of the embodiments.

The methods disclosed in several method embodiments provided in the present disclosure may be arbitrarily combined without conflict to obtain new method embodiments.

The features disclosed in several product embodiments provided in the present disclosure may be arbitrarily combined without conflict to obtain new product embodiments.

The features disclosed in several method or device embodiments provided in the present disclosure may be arbitrarily combined without conflict to obtain new method embodiments or device embodiments.

In a first clause, provided is a decoding method, in which the method is applied to a decoder and includes:
determining planar structure information of neighborhood nodes of a current node;
determining context indication information of the current node according to the planar structure information of the neighborhood nodes;
determining target context information according to the context indication information; and
decoding a bitstream based on the target context information to determine planar position information of the current node.

In a second clause, according to the method of the first clause, the neighborhood nodes include at least one of: at least one co-planar node sharing a face with the current node, at least one co-edge node sharing an edge with the current node, or at least one co-vertex node sharing a vertex with the current node.

In a third clause, according to the method of the second clause, where determining the context indication information of the current node according to the planar structure information of the neighborhood nodes includes:
determining planar structure information of first-type neighborhood nodes and planar structure information of second-type neighborhood nodes according to the planar structure information of the neighborhood nodes;
determining first context indication information of the current node according to the planar structure information of the first-type neighborhood nodes; and
determining second context indication information of the current node according to the planar structure information of the second-type neighborhood nodes.

In a fourth clause, according to method of the third clause, where in response to the first-type neighborhood nodes including three co-planar nodes sharing a face with the current node, determining the planar structure information of the first-type neighborhood nodes includes:
determining occupancy information of the three co-planar nodes;
determining planar flag information of the three co-planar nodes and planar position information of the three co-planar nodes according to the occupancy information of the three co-planar nodes; and
composing the planar structure information of the first-type neighborhood nodes according to the planar flag information of the three co-planar nodes and the planar position information of the three co-planar nodes; and
correspondingly, where determining the first context indication information of the current node according to the planar structure information of the first-type neighborhood nodes includes:
determining the first context indication information of the current node according to the planar flag information of the three co-planar nodes and the planar position information of the three co-planar nodes.

In a fifth clause, according to the method of the third clause, where in response to the second-type neighborhood nodes including three co-edge nodes sharing an edge with the current node and one co-vertex node sharing a vertex with the current node, determining the planar structure information of the second-type neighborhood nodes includes:
determining occupancy information of the three co-edge nodes and occupancy information of the one co-vertex node;
determining planar flag information of the three co-edge nodes and planar position information of the three co-edge nodes according to the occupancy information of the three co-edge nodes, and determining planar flag information of the one co-vertex node and planar position information of the one co-vertex node according to the occupancy information of the one co-vertex node; and
composing the planar structure information of the second-type neighborhood nodes according to the planar flag information of the three co-edge nodes, the planar flag information of the one co-vertex node, the planar position information of the three co-edge nodes and the planar position information of the one co-vertex node; and
correspondingly, where determining the second context indication information of the current node according to the planar structure information of the second-type neighborhood nodes includes:
determining the second context indication information of the current node according to the planar flag information of the three co-edge nodes, the planar flag information of the one co-vertex node, the planar position information of the three co-edge nodes and the planar position information of the one co-vertex node.

In a sixth clause, according to the method of the second clause, where determining the context indication information of the current node according to the planar structure information of the neighborhood nodes includes:
determining first-type planar structure information of the neighborhood nodes and second-type planar structure information of the neighborhood nodes according to the planar structure information of the neighborhood nodes;
determining first context indication information of the current node according to the first-type planar structure information of the neighborhood nodes; and
determining second context indication information of the current node according to the second-type planar structure information of the neighborhood nodes.

In a seventh clause, according to the method of the sixth clause, where in response to the neighborhood nodes including three co-planar nodes sharing a face with the current node, three co-edge nodes sharing an edge with the current node and one co-vertex node sharing a vertex with the current node, determining the first-type planar structure information of the neighborhood nodes includes:
determining respective occupancy information of the three co-planar nodes, the three co-edge nodes and the one co-vertex node;
determining, according to the respective occupancy information of the three co-planar nodes, the three co-edge nodes and the one co-vertex node, planar position information of the three co-planar nodes, planar position information of the three co-edge nodes and planar position information of the one co-vertex node; and
composing the first-type planar structure information of the neighborhood nodes according to the planar position information of the three co-planar nodes, the planar position information of the three co-edge nodes and the planar position information of the one co-vertex node; and
correspondingly, where determining the first context indication information of the current node according to the first-type planar structure information of the neighborhood nodes includes:
determining the first context indication information of the current node according to the planar position information of the three co-planar nodes, the planar position information of the three co-edge nodes and the planar position information of the one co-vertex node.

In an eighth clause, according to the method of the sixth clause, where in response to the neighborhood nodes including three co-planar nodes sharing a face with the current node, three co-edge nodes sharing an edge with the current node and one co-vertex node sharing a vertex with the current node, determining the second-type planar structure information of the neighborhood nodes includes:
determining respective occupancy information of the three co-planar nodes, the three co-edge nodes and the one co-vertex node;
determining, according to the respective occupancy information of the three co-planar nodes, the three co-edge nodes and the one co-vertex node, planar flag information of the three co-planar nodes, planar flag information of the three co-edge nodes and planar flag information of the one co-vertex node; and
composing the second-type planar structure information of the neighborhood nodes according to the planar flag information of the three co-planar nodes, the planar flag information of the three co-edge nodes and the planar flag information of the one co-vertex node; and
correspondingly, where determining the second context indication information of the current node according to the second-type planar structure information of the neighborhood nodes includes:
determining the second context indication information of the current node according to the planar flag information of the three co-planar nodes, the planar flag information of the three co-edge nodes and the planar flag information of the one co-vertex node.

In a ninth clause, according to the method of the third or sixth clause, where determining the target context information according to the context indication information includes:
determining the first context indication information of the current node and the second context indication information of the current node; and
determining the target context information according to the first context indication information and the second context indication information.

In a tenth clause, according to the method of the ninth clause, where determining the target context information according to the first context indication information and the second context indication information includes:
performing context mapping processing according to the first context indication information and the second context indication information, to obtain new context information; and
determining the target context information according to the new context information.

In an eleventh clause, according to the method of the ninth clause, where determining the target context information according to the context indication information includes:
determining reference context information of the current node; and
determining the target context information according to the first context indication information, the second context indication information and the reference context information.

In a twelfth clause, according to the method of the eleventh clause, where determining the reference context information of the current node includes at least one of:
performing prediction according to occupancy information of the neighborhood nodes to determine a prediction value of the planar position information of the current node, where the prediction value includes one of: low plane, high plane, or unpredictable;
determining a spatial distance between a node at a same partitioning depth and a same coordinate as the current node and the current node, where the spatial distance includes one of: near distance or far distance;
determining whether a node at a same partitioning depth and a same coordinate as the current node is a plane, and in response to the node being a plane, determining a planar position of the node; or
determining coordinate dimension information of the current node.

In a thirteenth clause, provided is an encoding method, in which the method is applied to an encoder and includes:
determining planar structure information of neighborhood nodes of a current node;
determining context indication information of the current node according to the planar structure information of the neighborhood nodes;
determining target context information according to the context indication information;
determining planar position information of the current node; and
encoding the planar position information of the current node based on the target context information, and signalling obtained encoded bits into a bitstream.

In a fourteenth clause, according to the method of the thirteenth clause, where determining the planar position information of the current node includes:
in response to the current node satisfying a condition for planar coding, determining the planar position information of the current node to be one of: low planar position information or high planar position information.

In a fifteenth clause, according to the method of the thirteenth clause, the neighborhood nodes include at least one of: at least one co-planar node sharing a face with the current node, at least one co-edge node sharing an edge with the current node, or at least one co-vertex node sharing a vertex with the current node.

In a sixteenth clause, according to the method of the fifteenth clause, where determining the context indication information of the current node according to the planar structure information of the neighborhood nodes includes:
determining planar structure information of first-type neighborhood nodes and planar structure information of second-type neighborhood nodes according to the planar structure information of the neighborhood nodes;
determining first context indication information of the current node according to the planar structure information of the first-type neighborhood nodes; and
determining second context indication information of the current node according to the planar structure information of the second-type neighborhood nodes.

In a seventeenth clause, according to the method of the sixteenth clause, where in response to the first-type neighborhood nodes including three co-planar nodes sharing a face with the current node, determining the planar structure information of the first-type neighborhood nodes includes: determining occupancy information of the three co-planar nodes;
determining planar flag information of the three co-planar nodes and planar position
information of the three co-planar nodes according to the occupancy information of the three co-planar nodes; and
composing the planar structure information of the first-type neighborhood nodes according to the planar flag information of the three co-planar nodes and the planar position information of the three co-planar nodes; and
correspondingly, where determining the first context indication information of the current node according to the planar structure information of the first-type neighborhood nodes includes:
determining the first context indication information of the current node according to the planar flag information of the three co-planar nodes and the planar position information of the three co-planar nodes.

In an eighteenth clause, according to the method of the sixteenth clause, where in response to the second-type neighborhood nodes including three co-edge nodes sharing an edge with the current node and one co-vertex node sharing a vertex with the current node, determining the planar structure information of the second-type neighborhood nodes includes:
determining occupancy information of the three co-edge nodes and occupancy information of the one co-vertex node;
determining planar flag information of the three co-edge nodes and planar position information of the three co-edge nodes according to the occupancy information of the three co-edge nodes, and determining planar flag information of the one co-vertex node and planar position information of the one co-vertex node according to the occupancy information of the one co-vertex node; and
composing the planar structure information of the second-type neighborhood nodes according to the planar flag information of the three co-edge nodes, the planar flag information of the one co-vertex node, the planar position information of the three co-edge nodes and the planar position information of the one co-vertex node; and
correspondingly, where determining the second context indication information of the current node according to the planar structure information of the second-type neighborhood nodes includes:
determining the second context indication information of the current node according to the planar flag information of the three co-edge nodes, the planar flag information of the one co-vertex node, the planar position information of the three co-edge nodes and the planar position information of the one co-vertex node.

In a nineteenth clause, according to the method of the fifteenth clause, where determining the context indication information of the current node according to the planar structure information of the neighborhood nodes includes:
determining first-type planar structure information of the neighborhood nodes and second-type planar structure information of the neighborhood nodes according to the planar structure information of the neighborhood nodes;
determining first context indication information of the current node according to the first-type planar structure information of the neighborhood nodes; and
determining second context indication information of the current node according to the second-type planar structure information of the neighborhood nodes.

In a twentieth clause, according to the method of the nineteenth clause, where in response to the neighborhood nodes including three co-planar nodes sharing a face with the current node, three co-edge nodes sharing an edge with the current node and one co-vertex node sharing a vertex with the current node, determining the first-type planar structure information of the neighborhood nodes includes:
determining respective occupancy information of the three co-planar nodes, the three co-edge nodes and the one co-vertex node;
determining, according to the respective occupancy information of the three co-planar nodes, the three co-edge nodes and the one co-vertex node, planar position information of the three co-planar nodes, planar position information of the three co-edge nodes and planar position information of the one co-vertex nodes; and
composing the first-type planar structure information of the neighborhood nodes according to the planar position information of the three co-planar nodes, the planar position information of the three co-edge nodes and the planar position information of the one co-vertex node; and
correspondingly, where determining the first context indication information of the current node according to the first-type planar structure information of the neighborhood nodes includes:
determining the first context indication information of the current node according to the planar position information of the three co-planar nodes, the planar position information of the three co-edge nodes and the planar position information of the one co-vertex node.

In a twenty-first clause, according to the method of the nineteenth clause, where in response to the neighborhood nodes including three co-planar nodes sharing a face with the current node, three co-edge nodes sharing an edge with the current node and one co-vertex node sharing a vertex with the current node, determining the second-type planar structure information of the neighborhood nodes includes:
determining respective occupancy information of the three co-planar nodes, the three co-edge nodes and the one co-vertex node;
determining, according to the respective occupancy information of the three co-planar nodes, the three co-edge nodes and the one co-vertex node, planar flag information of the three co-planar nodes, planar flag information of the three co-edge nodes and planar flag information of the one co-vertex node; and
composing the second-type planar structure information of the neighborhood nodes according to the planar flag information of the three co-planar nodes, the planar flag information of the three co-edge nodes and the planar flag information of the one co-vertex node; and
correspondingly, where determining the second context indication information of the current node according to the second-type planar structure information of the neighborhood nodes includes:
determining the second context indication information of the current node according to the planar flag information of the three co-planar nodes, the planar flag information of the three co-edge nodes and the planar flag information of the one co-vertex node.

In a twenty-second clause, according to the method of the sixteenth or nineteenth clause, where determining the target context information according to the context indication information includes:
determining the first context indication information of the current node and the second context indication information of the current node; and
determining the target context information according to the first context indication information and the second context indication information.

In a twenty-third clause, according to the method of the twenty-second clause, where determining the target context information according to the first context indication information and the second context indication information includes:
performing context mapping processing according to the first context indication information and the second context indication information, to obtain new context information; and
determining the target context information according to the new context information.

In a twenty-fourth clause, according to the method of the twenty-second clause, where determining the target context information according to the context indication information includes: determining reference context information of the current node; and determining the target context information according to the first context indication
information, the second context indication information and the reference context information.

In a twenty-fifth clause, according to the method of the twenty-fourth clause, where determining the reference context information of the current node includes at least one of:
performing prediction according to occupancy information of the neighborhood nodes to determine a prediction value of the planar position information of the current node, where the prediction value includes one of: low planar, high planar, or unpredictable;
determining a spatial distance between a node at a same partition depth and a same coordinate as the current node and the current node, where the spatial distance satisfies one of: near distance or far distance;
determining whether a node at a same partition depth and a same coordinate as the current node is a plane, and if the node is a plane, determining a planar position of the node; or
determining coordinate dimension information of the current node.

In a twenty-sixth clause, provided is a bitstream, where the bitstream is generated by bit encoding according to information to be encoded; and the information to be encoded includes at least: planar position information of a current node.

In a twenty-seventh clause, provided is an encoder, in which the encoder includes: a first determining unit and an encoding unit; where
the first determining unit is configured to determine planar structure information of neighborhood nodes of a current node; determine context indication information of the current node according to the planar structure information of the neighborhood nodes; determine target context information according to the context indication information; and determine planar position information of the current node; and
the encoding unit is configured to encode the planar position information of the current node based on the target context information, and signal obtained encoded bits into a bitstream.

In a twenty-eighth clause, provided is an encoder, in which the encoder includes: a first memory and a first processor; where
the first memory is configured to store a computer program executable on the first processor; and
the first processor is configured to perform the method according to any one of the thirteenth to twenty-fifth clauses when executing the computer program.

In a twenty-ninth clause, provided is a decoder, in which the decoder includes: a second determining unit and a decoding unit; where
the second determining unit is configured to determine planar structure information of neighborhood nodes of a current node; determine context indication information of the current node according to the planar structure information of the neighborhood nodes; and determine target context information according to the context indication information; and
the decoding unit is configured to decode a bitstream based on the target context information to determine planar position information of the current node.

In a thirtieth clause, provided is a decoder, in which the decoder includes: a second memory and a second processor; where
the second memory is configured to store a computer program executable on the second processor; and
the second processor is configured to perform the method according to any one of the first to twelfth clauses when executing the computer program.

In a thirty-first clause, provided is a computer-readable storage medium, having a computer program stored thereon, where the computer program, when executed, implements the method according to any one of the first to twelfth clauses, or the method according to any one of the thirteenth to twenty-fifth clauses

The foregoing are merely specific implementations of the present disclosure, but the protection scope of the present disclosure is not limited thereto. Any person skilled in the art may readily conceive variations or substitutions within the technical scope disclosed by the present disclosure, which should be included within the protection scope of the present disclosure. Therefore, the protection scope of the present disclosure shall be subject to the protection scope of the claims.

### INDUSTRIAL APPLICABILITY

In the embodiments of the present disclosure, whether at the encoding side or the decoding side, the planar structure information of the neighborhood nodes of the current node is determined; the context indication information of the current node is determined according to the planar structure information of the neighborhood nodes; and the target context information is determined according to the context indication information. In this way, at the encoding side, after the planar position information of the current node is determined, the planar position information of the current node is encoded based on the target context information, and the obtained encoded bits are signalled into the bitstream; and at the decoding side, the bitstream may be decoded based on the target context information to determine the planar position information of the current node. That is, during the process of encoding and decoding the planar position information of the current node by using the target context information, the target context information may be determined through considering the planar structure information of the neighborhood nodes of the current node; moreover, through considering the correlation between the planar structure information of the neighborhood nodes, the geometry information coding efficiency of the point cloud is effectively improved, thereby improving the encoding and decoding performance of the point cloud.

What is claimed is:

1. A decoding method, applied to a decoder and comprising:
determining planar structure information of neighborhood nodes of a current node;
determining context indication information of the current node according to the planar structure information of the neighborhood nodes;
determining target context information according to the context indication information; and
decoding a bitstream based on the target context information to determine planar position information of the current node.

2. The method according to claim 1, wherein the neighborhood nodes comprise at least one of: at least one co-planar node sharing a face with the current node, at least one co-edge node sharing an edge with the current node, or at least one co-vertex node sharing a vertex with the current node.

3. The method according to claim 2, wherein determining the context indication information of the current node according to the planar structure information of the neighborhood nodes comprises:
determining planar structure information of first-type neighborhood nodes and planar structure information of second-type neighborhood nodes according to the planar structure information of the neighborhood nodes;
determining first context indication information of the current node according to the planar structure information of the first-type neighborhood nodes; and
determining second context indication information of the current node according to the planar structure information of the second-type neighborhood nodes.

4. The method according to claim 3, wherein in response to the first-type neighborhood nodes comprising three co-planar nodes sharing a face with the current node, determining the planar structure information of the first-type neighborhood nodes comprises:
determining planar flag information of the three co-planar nodes and planar position information of the three co-planar nodes according to occupancy information of the three co-planar nodes; and
composing the planar structure information of the first-type neighborhood nodes according to the planar flag information of the three co-planar nodes and the planar position information of the three co-planar nodes.

5. The method according to claim 4, wherein determining the first context indication information of the current node according to the planar structure information of the first-type neighborhood nodes comprises:
determining the first context indication information of the current node according to the planar flag information of the three co-planar nodes and the planar position information of the three co-planar nodes.

6. The method according to claim 3, wherein in response to the second-type neighborhood nodes comprising three co-edge nodes sharing an edge with the current node and one co-vertex node sharing a vertex with the current node, determining the planar structure information of the second-type neighborhood nodes comprises:
determining occupancy information of the three co-edge nodes and occupancy information of the one co-vertex node;
determining planar flag information of the three co-edge nodes and planar position information of the three co-edge nodes according to the occupancy information of the three co-edge nodes, and determining planar flag information of the one co-vertex node and planar position information of the one co-vertex node according to the occupancy information of the one co-vertex node; and
composing the planar structure information of the second-type neighborhood nodes according to the planar flag information of the three co-edge nodes, the planar flag information of the one co-vertex node, the planar position information of the three co-edge nodes and the planar position information of the one co-vertex node.

7. The method according to claim 6, wherein determining the second context indication information of the current node according to the planar structure information of the second-type neighborhood nodes comprises:
determining the second context indication information of the current node according to the planar flag information of the three co-edge nodes, the planar flag information of the one co-vertex node, the planar position information of the three co-edge nodes and the planar position information of the one co-vertex node.

8. The method according to claim 3, wherein the context indication information comprises the first context indication information and the second context indication information; and
determining the target context information according to the context indication information comprises:
determining the target context information according to the first context indication information and the second context indication information.

9. The method according to claim 8, wherein determining the target context information according to the context indication information comprises:
determining reference context information of the current node; and
determining the target context information according to the first context indication information, the second context indication information and the reference context information.

10. The method according to claim 9, wherein determining the reference context information of the current node comprises at least one of:
performing prediction according to occupancy information of the neighborhood nodes to determine a prediction value of the planar position information of the current node, wherein the prediction value comprises one of: low plane, high plane, or unpredictable;
determining a spatial distance between a node at a same partitioning depth and a same coordinate as the current node and the current node, wherein the spatial distance comprises one of: near distance or far distance;
determining whether a node at a same partitioning depth and a same coordinate as the current node is a plane, and in response to the node being a plane, determining a planar position of the node; or
determining coordinate dimension information of the current node.

11. An encoding method, applied to an encoder and comprising:
determining planar structure information of neighborhood nodes of a current node;
determining context indication information of the current node according to the planar structure information of the neighborhood nodes;
determining target context information according to the context indication information;
determining planar position information of the current node; and
encoding the planar position information of the current node based on the target context information, and signalling obtained encoded bits into a bitstream.

12. The method according to claim 11, wherein the neighborhood nodes comprise at least one of: at least one co-planar node sharing a face with the current node, at least one co-edge node sharing an edge with the current node, or at least one co-vertex node sharing a vertex with the current node.

13. The method according to claim 12, wherein determining the context indication information of the current node according to the planar structure information of the neighborhood nodes comprises:
determining planar structure information of first-type neighborhood nodes and planar structure information of second-type neighborhood nodes according to the planar structure information of the neighborhood nodes;
determining first context indication information of the current node according to the planar structure information of the first-type neighborhood nodes; and
determining second context indication information of the current node according to the planar structure information of the second-type neighborhood nodes.

14. The method according to claim 13, wherein in response to the first-type neighborhood nodes comprising three co-planar nodes sharing a face with the current node, determining the planar structure information of the first-type neighborhood nodes comprises:
determining planar flag information of the three co-planar nodes and planar position information of the three co-planar nodes according to occupancy information of the three co-planar nodes; and
composing the planar structure information of the first-type neighborhood nodes according to the planar flag information of the three co-planar nodes and the planar position information of the three co-planar nodes.

15. The method according to claim 14, wherein determining the first context indication information of the current node according to the planar structure information of the first-type neighborhood nodes comprises:
determining the first context indication information of the current node according to the planar flag information of the three co-planar nodes and the planar position information of the three co-planar nodes.

16. The method according to claim 13, wherein in response to the second-type neighborhood nodes comprising three co-edge nodes sharing an edge with the current node and one co-vertex node sharing a vertex with the current node, determining the planar structure information of the second-type neighborhood nodes comprises:
determining occupancy information of the three co-edge nodes and occupancy information of the one co-vertex node;
determining planar flag information of the three co-edge nodes and planar position information of the three co-edge nodes according to the occupancy information of the three co-edge nodes, and determining planar flag information of the one co-vertex node and planar position information of the one co-vertex node according to the occupancy information of the one co-vertex node; and
composing the planar structure information of the second-type neighborhood nodes according to the planar flag information of the three co-edge nodes, the planar flag information of the one co-vertex node, the planar position information of the three co-edge nodes and the planar position information of the one co-vertex node; and
wherein determining the second context indication information of the current node according to the planar structure information of the second-type neighborhood nodes comprises:
determining the second context indication information of the current node according to the planar flag information of the three co-edge nodes, the planar flag information of the one co-vertex node, the planar position information of the three co-edge nodes and the planar position information of the one co-vertex node.

17. The method according to claim 13, wherein the context indication information comprises the first context indication information and the second context indication information; and
determining the target context information according to the context indication information comprises:
determining the target context information according to the first context indication information and the second context indication information.

18. The method according to claim 17, wherein determining the target context information according to the context indication information comprises:
determining reference context information of the current node; and
determining the target context information according to the first context indication information, the second context indication information and the reference context information.

19. The method according to claim 18, wherein determining the reference context information of the current node comprises at least one of:
performing prediction according to occupancy information of the neighborhood nodes to determine a prediction value of the planar position information of the current node, wherein the prediction value comprises one of: low planar, high planar, or unpredictable;
determining a spatial distance between a node at a same partition depth and a same coordinate as the current node and the current node, wherein the spatial distance satisfies one of: near distance or far distance;
determining whether a node at a same partition depth and a same coordinate as the current node is a plane, and if the node is a plane, determining a planar position of the node; or
determining coordinate dimension information of the current node.

20. A computer-readable storage medium, having a computer program and a bitstream stored thereon, wherein the computer program, when executed by a processor, enables the processor to perform following steps to generate the bitstream:
determining planar structure information of neighborhood nodes of a current node;
determining context indication information of the current node according to the planar structure information of the neighborhood nodes;
determining target context information according to the context indication information;
determining planar position information of the current node; and
encoding the planar position information of the current node based on the target context information, and signalling obtained encoded bits into the bitstream.
